(19) United States
(12) Patent Application Publication
(10) Pub. No.: US 2015/0248461 A1
(43) Pub. Date: Sep. 3, 2015

(54) STREAMING QUERY DEPLOYMENT OPTIMIZATION

(71) Applicants: Bart A. Theeten, Sinaai-Waas (BE); Nico Janssens, Putte (BE)

(72) Inventors: Bart A. Theeten, Sinaai-Waas (BE); Nico Janssens, Putte (BE)

(73) Assignee: Alcatel Lucent, Paris (FR)

(21) Appl. No.: 14/193,460

(22) Filed: Feb. 28, 2014

(51) Int. Cl. G06F 17/30

(52) U.S. Cl. CPC G06F 17/30516; G06F 17/30433

(57) ABSTRACT

A streaming query control capability is presented herein. The streaming query control capability may support improvement or optimization of various aspects of streaming queries. The streaming query control capability may support improvements or optimization in streaming query performance within an environment. The streaming query control capability may support improvements in streaming query performance via improvements in deployment of a streaming query to an environment. The streaming query control capability may support improvements in streaming query performance via modification of a streaming query intended for execution in an environment based on measurement data collected from the environment. The streaming query control capability may support improvements in streaming query performance via integrated deployment and activation of multiple streaming queries sharing a common characteristic. Various combinations of such capabilities may be supported for improvement or optimization of various aspects of streaming queries.

### CROSS-REFERENCE TO RELATED APPLICATION

The present application may be related to the co-pending U.S. patent application entitled DYNAMICALLY IMPROVING STREAMING QUERY PERFORMANCE BASED ON COLLECTED MEASUREMENT DATA, Attorney Docket No. 815742-US-NP, which is hereby incorporated herein by reference in its entirety.

### TECHNICAL FIELD

The disclosure relates generally to streaming queries and, more specifically but not exclusively, to use of streaming queries in communication networks.

### BACKGROUND

Streaming data analytics involves real-time querying of live data for various purposes. The use of streaming data analytics continues to grow, as many companies that collect data are using streaming data analytics in order to obtain faster insights into the collected data (e.g., to more quickly identify events and trends, to react to events and trends more quickly, and the like). Additionally, for example, many companies subscribe to streams of various social media companies in order to obtain and analyze data that may be of interest to the companies (e.g., to obtain information regarding user posts of expectations or reviews of their products or services, to obtain information regarding sharing of user posts of interest, and the like), as the potential reach of such posts may be quite large and, thus, of great interest to the companies. Streaming data analytics typically relies upon deployment and execution of streaming queries within the environment for which streaming data analytics is to be performed.

### SUMMARY OF EMBODIMENTS

Various deficiencies in the prior art are addressed by embodiments for improving aspects of a streaming query.

In at least some embodiments, an apparatus includes a processor and a memory communicatively connected to the processor, where the processor is configured to determine a centralized query plan configured to provide a centralized deployment of the streaming query, determine a tree representing a distributed environment in which the streaming query is to be deployed, and determine, based on the centralized query plan and the tree representing the distributed environment in which the streaming query is to be deployed, a distributed query plan configured to provide a distributed deployment of the streaming query within the distributed environment.

In at least some embodiments, a method includes using a processor and a memory for determining a centralized query plan configured to provide a centralized deployment of the streaming query, determining a tree representing a distributed environment in which the streaming query is to be deployed, and determining, based on the centralized query plan and the tree representing the distributed environment in which the streaming query is to be deployed, a distributed query plan configured to provide a distributed deployment of the streaming query within the distributed environment.

In at least some embodiments, a computer-readable storage medium stores a set of instructions which, when executed by a computer, cause the computer to perform a method including determining a centralized query plan configured to provide a centralized deployment of the streaming query, determining a tree representing a distributed environment in which the streaming query is to be deployed, and determining, based on the centralized query plan and the tree representing the distributed environment in which the streaming query is to be deployed, a distributed query plan configured to provide a distributed deployment of the streaming query within the distributed environment.

In at least some embodiments, an apparatus includes a processor and a memory communicatively connected to the processor, where the processor is configured to identify a first streaming query and a second streaming query sharing a common characteristic, and determine, based on the common characteristic, a query plan configured for integrated deployment and execution of the first streaming query and the second streaming query within an environment.

In at least some embodiments, a method includes using a processor and a memory for identifying a first streaming query and a second streaming query sharing a common characteristic, and determining, based on the common characteristic, a query plan configured for integrated deployment and execution of the first streaming query and the second streaming query within an environment.

In at least some embodiments, a computer-readable storage medium stores a set of instructions which, when executed by a computer, cause the computer to perform a method including identifying a first streaming query and a second streaming query sharing a common characteristic, and determining, based on the common characteristic, a query plan configured for integrated deployment and execution of the first streaming query and the second streaming query within an environment.

### BRIEF DESCRIPTION OF THE DRAWINGS

The teachings herein can be readily understood by considering the detailed description in conjunction with the accompanying drawings, in which:

FIG. 1 depicts an exemplary communication system including a communication network within which streaming queries may be executed and including a streaming query control system configured to dynamically improve various aspects of streaming queries executing within the communication network;

FIGS. 2A and 2B depict an exemplary streaming query plan and an exemplary streaming query deployment for an exemplary streaming query;

FIG. 3 depicts an exemplary embodiment of the streaming query control system of FIG. 1, illustrating a process for generation of a streaming query and deployment of the streaming query to the communication network of FIG. 1;

FIG. 4 depicts one embodiment of a process for generating a distributed query plan for a streaming query based on a centralized query plan for the streaming query and a deployment topology description of an environment in which the streaming query is to be deployed;

FIG. 5 depicts an exemplary communication network configured for a top-N streaming query use case;

FIGS. 6A and 6B depict exemplary optimized deployments of a top-N streaming query on the exemplary communication network of FIG. 5;

FIG. 7 depicts an exemplary embodiment of a method for determining, deploying, and activating a streaming query within a distributed environment;

FIG. 8 depicts an exemplary wrapper architecture, for a wrapper for a query primitive of a streaming query plan of a streaming query, for collection of measurement data;

FIG. 9 depicts an exemplary deployment of taps on processing nodes and links between processing nodes for collection of measurement data;

FIG. 10 depicts an exemplary deployment of a combination of wrappers and taps for end-to-end collection of measurement data;

FIG. 11 depicts an embodiment of a method for generating a modified streaming query from a streaming query based on measurement data collected for the streaming query;

FIGS. 12A-12B depict two exemplary streaming queries to be deployed and activated within an environment;

FIG. 13 depicts an exemplary common query plan for the exemplary streaming queries of FIGS. 12A and 12B when exemplary streaming queries of FIGS. 12A and 12B have not been deployed or activated within the environment;

FIG. 14 depicts an exemplary embodiment of a method for creating a common streaming query plan for multiple streaming queries that have not been deployed or activated within the environment;

FIG. 15 depicts an exemplary deployment of the streaming query of FIG. 12A within an exemplary communication network;

FIG. 16 depicts an exemplary sub-query plan for the streaming query of FIG. 12B, to provide an integrated deployment and execution of the exemplary streaming queries of FIGS. 12A and 12B within the environment, when the query plan of FIG. 12A has been deployed to the environment as depicted in FIG. 15 and the query plan of FIG. 12B has not been deployed or activated within the environment;

FIG. 17 depicts an exemplary deployment of the sub-query plan of FIG. 16 to provide an integrated deployment of the exemplary streaming queries of FIGS. 12A and 12B within the communication network of FIG. 15;

FIG. 18 depicts an exemplary embodiment of a method for providing an integrated deployment of multiple streaming queries that include a streaming query that has been deployed and activated within the environment and a streaming query that has not been deployed or activated within the environment;

FIG. 19 depicts an exemplary embodiment of a method for providing an integrated deployment of multiple streaming queries; and

FIG. 20 depicts a high-level block diagram of a computer suitable for use in performing functions presented herein.

To facilitate understanding, identical reference numerals have been used, where possible, to designate identical elements common to the figures.

### DETAILED DESCRIPTION OF EMBODIMENTS

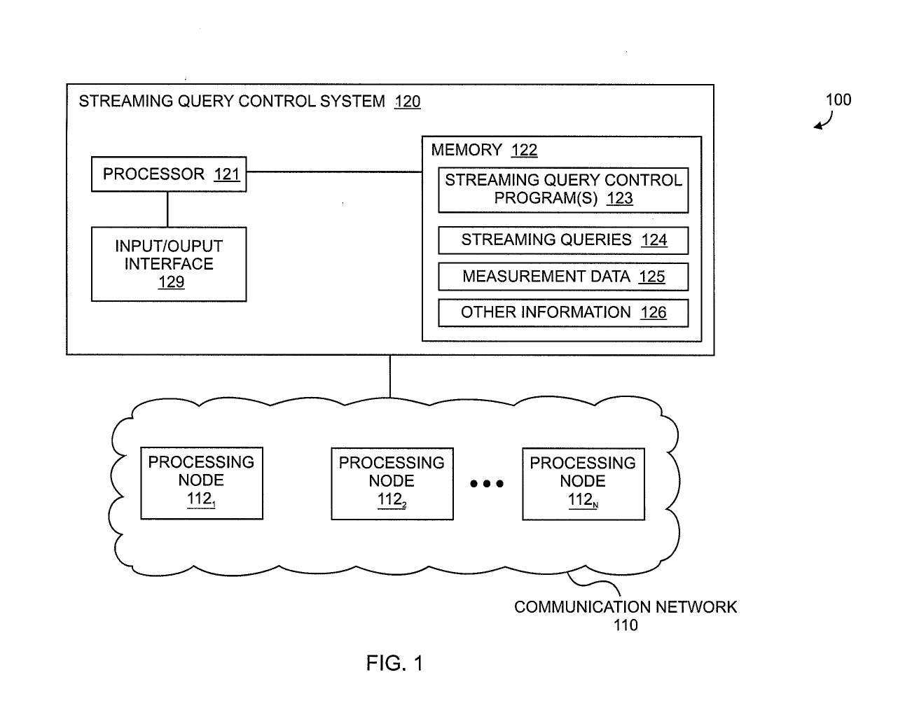

A streaming query control capability is presented herein. In at least some embodiments, the streaming query control capability may be configured to support improvements in, or even optimization of, streaming query performance within an environment. In at least some embodiments, the streaming query control capability may be configured to support improvements in streaming query performance via improvements in deployment of a streaming query to an environment. In at least some embodiments, the streaming query control capability may be configured to support improvements in streaming query performance via modification of a streaming query intended for execution within an environment based on measurement data collected from the environment. In at least some embodiments, the streaming query control capability may be configured to support improvements in streaming query performance via integrated deployment and activation of multiple streaming queries sharing a common characteristic (e.g., a common aggregation window or other suitable characteristic, which may be exploited to reduce the consumption of resources resulting from deployment and execution of the multiple streaming queries). In at least some embodiments, the streaming query control capability may be configured to support various combinations of such capabilities. Various embodiments of the streaming query control capability may be utilized within any suitable type of environment within which a streaming query may be executed (e.g., within a processor or other type of hardware, within a computer, within a network node, distributed within a communication network, within sensor networks or environments, within financial environments supporting propagation of ticker information, within environments using manufacturing processes, or the like); however, for purposes of clarity in describing embodiments of the capability for improving streaming query performance, embodiments of the capability for improving streaming query performance are primary depicted and described herein within the context of a telecommunication network, as depicted in FIG. 1.

FIG. 1 depicts an exemplary communication system including a communication network within which streaming queries may be executed and including a streaming query control system configured to dynamically improve various aspects of streaming queries executing within the communication network.

As depicted in FIG. 1, communication system 100 includes a communication network 110 and a streaming query control system (SQCS) 120 that is communicatively connected to communication network 110.

The communication network 110 may include any communication network(s) in which streaming queries may be deployed, such as various types of wireline networks, wireless networks, datacenters, enterprise networks, or the like, as well as various combinations thereof. For example, communication network 110 may include a radio access network (RAN) and a core wireless network. For example, communication network 110 may include a wireline access network (e.g., a cable network, a Digital Subscriber Line (DSL) network, or the like) and a core wireline network. For example, communication network 110 may include provider edge networks, provider backbone core networks, or the like. For example, the communication network 110 may include content distribution networks, datacenter networks, or the like. It will be appreciated that communication network 110 may represent any other suitable type(s) or combination(s) of networks in which streaming queries may be deployed.

The communication network 110 may produce or relay various data streams or event streams on which streaming queries may be executed. For example, data transmitted by end user devices (omitted for purposes of clarity) into the communication network may be data streams to which a streaming query may be applied (e.g., uploading of image-based content, voice calls, requests for web pages, or the like). For example, data transmitted by network devices (omitted for purposes of clarity) toward end user devices may be data streams to which a streaming query may be applied (e.g., streaming of video content from video servers, streaming of audio content from audio servers, responses to webpage requests, or the like). For example, call detail records generated within communication networks and transmitted toward billing centers for generation of customer bills may be data streams to which a streaming query may be applied. For example, sensor readings generated by sensors in an Internet-of-Things (IoT) setting or machine-to-machine (M2M) network may be data streams to which a streaming query may be applied. It will be appreciated that these are only a few examples of the types of data streams or event streams which may be generated within a communication network and, thus, to which streaming queries may be applied within the context of a communication network. The various types of event streams or data streams to which streaming queries may be applied within the context of a communication network (as well as various other types of environments in which streaming queries may be used) will be understood by one skilled in the art.

The communication network 110 includes a set of processing nodes 112₁-112_{N} (collectively, processing nodes 112). The processing nodes 112 may include any nodes configured to support execution of streaming queries (and, thus, also may be referred to herein as streaming query execution nodes 112). For example, processing nodes 112 may include existing nodes of the communication network in which streaming queries are deployed (e.g., NodeBs in a Universal Mobile Telecommunications System (UMTS) RAN, eNodeBs in a Long Term Evolution (LTE) RAN, Serving Gateways (SGWs) in an LTE core network, Packet Data Network (PDN) gateways (PGWs) in an LTE core network, routers or switches in a wireless or wireline access network, routers or switches in a wireless or wireline core network, network functions, virtual machines (VM) in a virtual network environment, or the like, as well as various combinations thereof). It will be appreciated that existing nodes on which processing nodes 112 are deployed may depend on the type(s) of communication network(s) of which communication network 110 is composed. For example, processing nodes 112 may include nodes specifically deployed for the purpose of supporting streaming queries in the communication network 110. The processing nodes 112 may include any other type(s) of node(s) suitable for supporting execution of streaming queries within a communication network.

The SQCS 120 is configured to provide various functions supporting use of streaming queries within communication network 110. In general, a streaming query, which also may be referred to herein as a continuous query, is configured to collect a subset of data from data streams to which the streaming query is applied (e.g., collecting values for a subset of parameters of the full set of parameters available from the data stream to which the streaming query is applied). For example, streaming queries may include Top-N queries (e.g., the top N mobile devices downloading content based on quantity of content downloaded, the top N content servers based on quantity of content delivered, or the like), Bottom-N queries, or any other types of queries which may be implemented as streaming queries. The typical operation of streaming queries will be understood by one skilled in the art. It will be appreciated that, as streaming queries typically operate on live data streams, streaming queries do not have the capability to know the data on which the streaming queries will need to operate and, thus, optimization of streaming queries is expected to be different from optimizing regular database queries (such as SQL queries in relational database management system (RDBMS) technology).

The SQCS 120 is configured to provide various functions supporting use of streaming queries within communication network 110. For example, SQCS 120 may be configured to support event stream processing (ESP), complex event processing (CEP), and other types of processing related to creation, deployment, and execution of streaming queries. For example, SQCS 120 may be configured to support ESP functions such as supporting a query primitive library (e.g., set of query primitives for doing real-time computations over a set of processing nodes), providing streaming query deployment and activation functions, providing streaming query management functions, providing detailed streaming query progress tracking, providing support for one or more streaming query Application Programming Interfaces (APIs), providing support for various processing semantics (e.g., “at-least-once” processing semantics, “exactly-once” processing semantics, or the like) through support of transactions, providing processing node management functions (e.g., support for handling processing node failures, additions, removals, or the like), or the like, as well as various combinations thereof. For example, SQCS 120 may be configured to support CEP functions using a higher-level streaming query language (which may be referred to herein as CHiveQL) on top of the query primitive library.

The SQCS 120 may be configured to determine a streaming query, deploy the streaming query to the communication network 110, and activate the streaming query within the communication network. The streaming query may be determined by retrieving the streaming query where the streaming query has already been generated, by generating the streaming query (e.g., by transforming a query expression (e.g., specified in a query language, such as a language similar to SQL or using any other suitable type of query language) into a sequence of processing steps configured to execute the streaming query), or the like. In general, a streaming query is specified as a streaming query plan and a streaming query deployment plan. The streaming query may be determined and deployed using a query plan compiler and a query execution engine, as discussed in additional detail below.

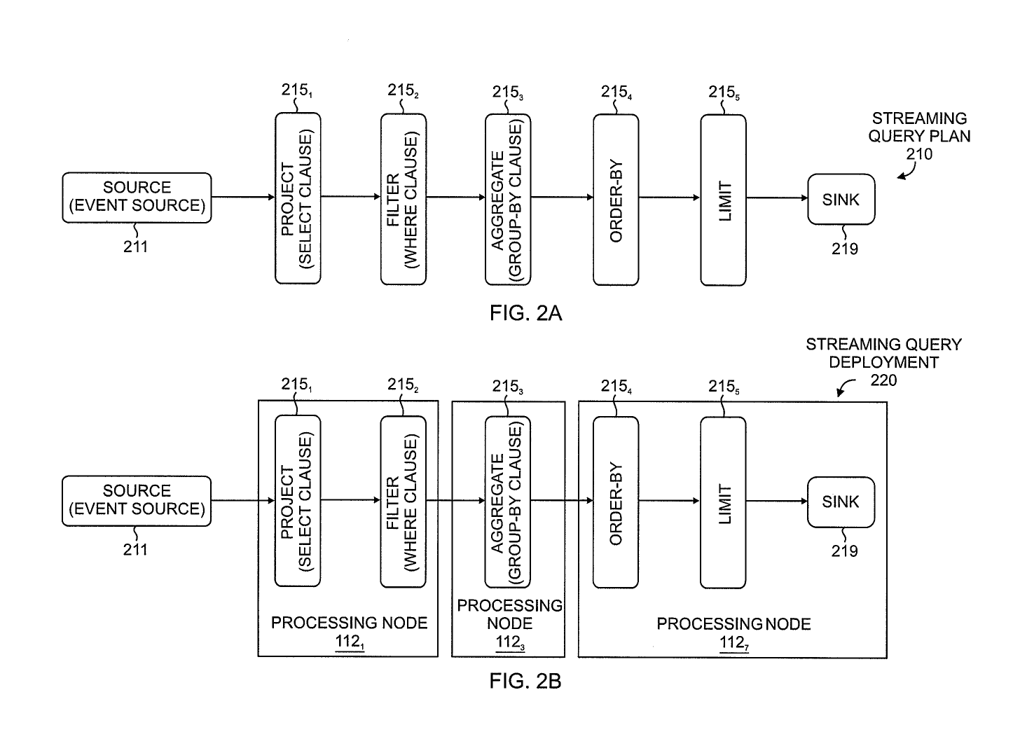

The streaming query plan of a streaming query includes a description of the streaming query plan. The streaming query plan of a streaming query typically includes at least one SOURCE node (representing the source(s) of any event streams to which the streaming query is to be applied) and a SINK node (e.g., representing the resulting output of the streaming query). The streaming query plan of a streaming query also includes a set of query primitives to be executed as part of the streaming query, such that a query primitive of a streaming query will be understood to implement a part of the streaming query. For example, streaming query primitives may include primitives such as FILTER, PROJECT, GROUP-BY, ORDER-BY, LIMIT, AGGREGATE, UNION, MAP, JOIN, or the like, at least some of which are described in additional detail below. The streaming query plan specifies a sequence for the query primitives of the streaming query plan (which also may be referred to as a flow through a sequence of query primitives). The sequence for the query primitives of the streaming query plan is typically defined between the SOURCE node and the SINK node. The streaming query plan for a streaming query may be generated based on a streaming query expression (e.g., specified as a query string) for the streaming query. The relationship between a streaming query expression and a streaming query plan generated based on the streaming query expression may be better understood by considering the following example. For example, an exemplary streaming query expression for calculating the top 10 HTTP hosts based on download footprint, may be specified as follows.
SELECT http_host, SUM(download_bytes) as download_volume
FROM EventSource.win:time(15 min)
WHERE http_host !=“unknown”
GROUP-BY http_host
ORDER-BY download_volume DESC
LIMIT 10
   The exemplary streaming query expression defined above may be processed to generate a corresponding streaming query plan for the streaming query, as depicted in FIG. 2A. As depicted in FIG. 2A, streaming query plan 210 includes a query SOURCE 211 (representing the source(s) of events to which the streaming query plan 210 is to be applied) and a query SINK 219 (representing output of the query results of streaming query plan 210) connected via a serial arrangement of query primitives that includes a PROJECT primitive 215₁ (corresponding to the SELECT clause of the streaming query expression above), a FILTER primitive 215₂ (corresponding to the WHERE clause of the streaming query expression above), an AGGREGATE primitive 215₃ (corresponding to the GROUP-BY clause of the streaming query expression above), a ORDER-BY primitive 215₄ (corresponding to the ORDER-BY clause of the streaming query expression above) and a LIMIT primitive 215₅ (corresponding to the LIMIT clause of the streaming query expression above). It will be appreciated that a query plan may be seen as an internal structure that directly maps onto a process flow.

The streaming query deployment of a streaming query includes a description of the streaming query deployment. The streaming query deployment of a streaming query defines a deployment of the streaming query within the environment in which the streaming query is to be executed (e.g., the communication network 110 of FIG. 1). The streaming query deployment may specify mapping of the query primitives of the streaming query plan of the streaming query to the processing nodes on which the query primitives of the streaming query plan of the streaming query are to be executed (e.g., on processing nodes 112 of the communication network 110 of FIG. 1). For example, for a streaming query having a streaming query plan including query primitives of PROJECT, FILTER, AGGREGATE, ORDER-BY, and LIMIT, the streaming query deployment for the streaming query may specify that the PROJECT and FILTER primitives are deployed on a first processing node 112, the AGGREGATE and ORDER-BY primitives are deployed on a second processing node 112, and the LIMIT primitive is deployed on a third processing node 112. The streaming query deployment may specify mapping of the query primitives of the streaming query plan to specific elements (omitted for purposes of clarity) on processing nodes on which the query primitives are to be executed (e.g., to specific processors of the processing nodes, to specific processor cores of the processing nodes, to specific tasks or threads of virtual machines in a virtual environment, or the like, which may depend on the type of processing nodes being used to support the streaming query). The streaming query deployment of a streaming query may define deployment of the streaming query based on degree of parallelism (e.g., across processing nodes, across elements of a processing node(s), or the like). The streaming query deployment of a streaming query may specify various types of connections, such as connections between the SOURCE node(s) and one or more query primitives of the streaming query plan, connections between the query primitives of the streaming query (e.g., connections between processing nodes, connections between elements within and between processing nodes, or the like, as well as various combinations thereof), and connections between one or more query primitives of the streaming query plan and the SINK node. The streaming query deployment of a streaming query may specify mapping of the query primitives of the streaming query in the form of streaming query components of the query primitives, where the streaming query component(s) of a given query primitive may represent the implementation code of the query primitive. The streaming query deployment of a streaming query may specify mapping of the query primitives of the streaming query in the form of mappings of streaming query components of the query primitives of the streaming query to elements of the processing nodes on which the streaming query is deployed (e.g., mapping of streaming query components to specific processing nodes, processors of processing nodes, processor cores of processing nodes, tasks or threads of virtual machines in a virtual environment, or the like). The streaming query deployment of a streaming query may define any other information related to deployment of a streaming query, in accordance with the streaming query plan, within a communication network. An exemplary streaming query deployment is depicted in FIG. 2B. More specifically, FIG. 2B depicts an exemplary streaming query deployment 220 for the exemplary streaming query plan 210 of FIG. 2A. The streaming query deployment 220 specifies that the PROJECT primitive 215₁ and the FILTER primitive 215₂ of streaming query plan 210 are to be deployed on processing node 112₁, that the AGGREGATE primitive 215₃ of streaming query plan 210 is to be deployed on processing node 112₃, and that the ORDER-BY primitive 215₄, the LIMIT primitive 215₅, and SINK 219 of streaming query plan 210 are to be deployed on processing node 112₇. It will be appreciated that the streaming query plan 210 may be deployed on processing nodes 112 in any other suitable manner (e.g., using fewer or more processing nodes 112, using different processing nodes 112, assigning portions of the streaming query plan to specific elements of one or more of the processing nodes 112, distributing portions of the streaming query plan 210 differently, deploying multiple instances of one or more query primitives on the same or different processing nodes, or the like, as well as various combinations thereof).

The SQCS 120 may be configured to deploy the streaming query within communication network 110. The streaming query is deployed within the communication network 110 based on the streaming query deployment specified for the streaming query. The streaming query may be deployed within communication network 110 by compiling the streaming query using a streaming query compiler in order to produce the streaming query deployment of the streaming query according to which the streaming query is deployed to the communication network 110. The streaming query may be deployed within communication network 110 by sending configuration messages to certain processing nodes 112 for triggering configuration of the processing nodes 112 (and, where relevant, components of the processing nodes 112) to execute the query primitives of the streaming query plan based on the mapping of the query primitives of the streaming query plan to the processing nodes 112, respectively. It will be appreciated that the streaming query may be deployed within communication network 110 in any other suitable manner.

The SQCS 120 is configured to support a query language which may be used to specify streaming queries which may be deployed to and executed within communication network 110. The query language supported by SQCS 120 may be used to specify streaming query expressions which may be processed in order to generate corresponding streaming query plans which are then used to deploy and activate the streaming queries. The query language supported by SQCS 120 may be an SQL-based or SQL-like event processing language (EPL) configured to support streaming analytics (e.g., replacing database tables with event streams, so as to generate query results in a continuous fashion). The query language supported by SQCS 120 may be a newly designed query language or a modified version of an existing query language. As discussed above, the query language supported by SQCS 120 may support clauses such as SELECT, FROM, WHERE, GROUP-BY, HAVING, ORDER-BY, LIMIT, or the like. Additionally, the query language supported by SQCS 120 may support various SQL extensions that support the expression of streaming queries, including statements to derive and aggregate information from one or more streams of events, statements to join or merge event streams, or the like, as well as various combinations thereof. Additionally, the query language supported by SQCS 120 may support definition of various types of window-based views on data streams, including time-based windows (e.g. to keep the events generated during the last 15 minutes, during the last 30 minutes, or the like) and fixed-length windows (e.g., to keep 10K events in memory, to keep 50K events in memory, or the like), each in a sliding or tumbling version. The query language supported by SQCS 120 may support various other functions as discussed herein. An exemplary streaming query expression that may be defined based on the query language supported by SQCS 120 follows. The exemplary streaming query expression is for a streaming query that calculates, each second, the top-10 HTTP hosts generating the highest download volumes, based on network measurements collected during the last 15 minutes. It is noted that this exemplary streaming query expression (as well as variations thereof) will be used again below to illustrate various functions supported by SQCS 120.
SELECT http_host, SUM(rec_bytes) AS download_volume
FROM EventSource.win:time(15 min)
WHERE http_host < > ‘unknown’
GROUP-BY http_host
OUTPUT SNAPSHOT EVERY 1 sec
ORDER-BY download_volume desc
LIMIT 10
   The query language supported by SQCS 120 may be configured to support improved or optimized streaming query deployment where the improvement or optimization may be based on one or more improvement or optimization parameters (e.g., bandwidth, processing efficiency, or the like). The query language supported by SQCS 120 may be configured to support improved or optimized streaming query deployment based on a set of extensions, at least some of which are discussed below. For purposes of clarity in describing extensions which may be supported by the query language supported by SQCS 120, the extensions described below are related to a particular improvement or optimization parameter (namely, bandwidth-improved or bandwidth-optimized streaming query deployment) related to improved or optimized deployment of streaming queries in communication network 110.

In at least some embodiments, the query language supported by SQCS 120 is configured to support a set of stream volume annotations. The set of stream volume annotations may be configured to enable use of hints or context information in order to help a streaming query compiler of SQCS 120 to calculate a bandwidth-improved or bandwidth-optimized query deployment plan. The hints or context information may be determined automatically, provided by a data analyst, provided by a data analyst initially and then updated automatically based on measurement data, or the like, as well as various combinations thereof. In general, a query plan of a streaming query may be internally represented as a weighted directed acyclic graph (WDAG). When searching for the most optimal plan (e.g., query plan, query deployment plan, or the like), a streaming query compiler of SQCS 120 calculates the end-to-end stream data volume that each candidate plan is expected to generate. This generally requires knowledge about the expected event creation rate of each event source and knowledge about the event reduction ratio of each query primitive included in the plan (indicating how the output rate of the query primitive relates to the input rate of the query primitive). The streaming query compiler of SQCS 120 may be configured to deduce such information from a streaming query using the set of stream volume annotations of the query language supported by SQCS 120. An example of a streaming query expression (again, configured to calculate the top-N hosts generating the largest download volumes) annotated based on stream volume annotations follows.
SELECT http_host, SUM(rec_bytes) AS download_volume
FROM EventSource.WIN:TIME(15 MIN) @EVENT_RATE=10000
WHERE http_host < >‘unknown’ @PASS_RATIO=0.3
GROUP-BY http_host @NUM_GROUPS=100
OUTPUT SNAPSHOT EVERY 1 sec
ORDER-BY download_volume DESC
LIMIT 10
   As depicted in the exemplary streaming query expression above, the query language supported by SQCS 120 may support various types of stream volume annotations.

For example, as depicted in the exemplary streaming query expression above, each event source can be extended with an @EVENT_RATE annotation that expresses the expected output rate of the source.

For example, as depicted in the exemplary streaming query expression above, filter operations, such as WHERE and HAVING clauses, can be annotated with @PASS_RATIO annotations that hint the fraction of events that are expected to pass the filters (although it is noted that this may depend on the expected data distribution of the generated events).

For example, as depicted in the exemplary streaming query expression above, for a streaming query that includes aggregation window operations defined by GROUP-BY clauses, an @NUM_GROUPS annotation may be used to specify the anticipated number of groups that the affected window will collect, and a streaming query compiler of SQCS 120 can calculate the event reduction ratio of each GROUP-BY operation based on the output creation rate defined in the aggregation window (e.g., defined in the query, such as every 1 second for the exemplary top-N query provided above), the expected number of group records collected in the aggregation window, and the expected event arrival rate (e.g., deduced from upstream primitives in the WDAG).

For example, although the exemplary streaming query expression above does not include JOIN operations (which may be used to join streams), JOIN operations may be annotated using an @JOIN_FACTOR annotation which enables specification (e.g., by a data analyst) of the associated event reduction/increase ratio (e.g., reduction ratio (O<@JOIN_FACTOR<1) or increase ratio (1<@JOIN_FACTOR)). It is noted that the reduction/increase ratio for an @JOIN_FACTOR annotation may depend on the actual data distribution and the join conditions (such that it may be necessary for hints from a data analyst in order to instantiate this annotation). An exemplary use of an @JOIN_FACTOR annotation within a streaming query expression follows.
FROM Foo.WIN:TIME(10 sec) AS foo
JOIN Bar.WIN:TIME(30 sec) AS bar
ON foo.a=bar.a AND foo.b=bar.c @JOIN_FACTOR=3

It is noted that at least some streaming query expression clauses (e.g., ORDER-BY, LIMIT, and the like) do not require input from the data analyst in order to deduce the associated event reduction ratio. For example, the event reduction ratio for ORDER-BY operations is known to be 1, and a streaming query compiler of SQCS 120 can deduce the event reduction ratio for LIMIT operations based on the specified row count.

It will be appreciated that the query language supported by SQCS 120 may support various other types of stream volume annotations.

In at least some embodiments, the query language supported by SQCS 120 is configured to support an annotation for natural data partitioning. The annotation for natural data partitioning may be used to indicate if a data stream is naturally partitioned on one or more GROUP-BY keys. For instance, considering a system in which each stream produces events for a mutually exclusive set of HTTP hosts, then these streams are considered to be naturally partitioned on the GROUP-BY key http_host. With this knowledge, a streaming query compiler of SQCS 120 can improve the intra-query parallelism of any related streaming queries by deploying separate aggregation windows (and, optionally, also ordering operations) for each stream, instead of a single aggregation window for all streams. It is noted that this optimization can be applied to the exemplary top-N query described above, as long as the parallel results are later put together in one set, ordered again, and limited to the 10 highest HTTP hosts. For example, the @PARTITIONED_ON annotation may be used to annotate the FROM clause of the exemplary streaming query expression described above as follows.
SELECT EventSource.WIN:TIME(15 min)
@EVENT_RATE=10000, @PARTITIONED_ON=[http_host]

In at least some embodiments, the query language supported by SQCS 120 is configured to support an annotation for explicit data partitioning. If streams are not naturally partitioned on a GROUP-BY key, but the attributes for this key that originate from different event streams overlap only occasionally, then it may still be beneficial to deploy separate aggregation windows as suggested above. If so, the event streams must be partitioned explicitly, delivering messages with the same key to the same aggregation window. This can be accomplished using well-established range or hash partitioning techniques. In order to indicate the need for explicit stream partitioning based on one or more GROUP-BY keys, the query language supported by SQCS 120 may include a PARTITION ON clause. The PARTITION ON clause may be implemented in a manner similar to a CLUSTER BY clause (e.g., see HIVE query language) which specifies the output columns that are hashed on in order to distribute data to various workers. For example, an exemplary use of a PARTITION ON statement, within the context of the exemplary streaming query expression above, follows.
SELECThttp_host, SUM(rec_bytes) AS download_volume
FROM EventSource.WIN:TIME(15 min) @EVENT_RATE=10000
   WHERE http_host < >‘unknown’ @PASS_RATIO=0.3
GROUP-BY http_host @NUM_GROUPS=100
PARTITION ON http_host
OUTPUT SNAPSHOT EVERY 1 sec
ORDER-BY download_volume DESC
LIMIT 10

In general, a query plan of a streaming query may be internally represented as a graph including a set of source nodes, a set of vertices, a set of edges, and a set of sink nodes. In at least some cases, query plan of a streaming query may be internally represented as a weighted directed acyclic graph (WDAG). In general, the set of source nodes includes one or more source nodes that symbolize the event stream(s) producing data tuples operated upon by the streaming query, the set of sink nodes includes one or more sink nodes that symbolize arrival of query results of the streaming query, and the set of source nodes and the set of sink nodes may be connected via the vertices and the edges of the WDAG.

The vertices of the WDAG represent query primitives that map one-to-one onto the query execution components offered by the underlying runtime platform. These query execution components may have one or more input gates (e.g., characterizing the mailboxes the affected query execution component uses to receive incoming data tuples), as well as one or more output gates (e.g., characterizing the mailboxes for delivering processed data tuples to a connected query execution component). In at least some embodiments, each gate may be strongly typed, declaring the schema of the data tuples being produced or consumed as well as their cardinality (singleton or set).

The edges of the WDAG represent data flows between the gates of compatible query execution components. In general, in order to be compatible, the schema of an input gate of a query execution component must be a subset of the output schema of the connected upstream neighbor of the query execution component. Additionally, the edges of a query plan are expected to comply with explicit ordering rules, which are used to define a partial ordering among compatible query execution components. These rules allow the imposition of extra ordering constraints on interchangeable query execution components (e.g., to enforce that a range component (e.g., responsible for selecting a tuple subset to implement a LIMIT clause) should not be executed before a compatible ordering component (which is responsible for ordering a set of data tuples to implement an ORDER-BY clause)). Additionally, the weights of the edges may quantify the expected data volumes to be exchanged between components (e.g., per time-unit or on any other suitable basis), which provides a metric which may be used to calculate the end-to-end stream volume that the streaming query is expected to generate over communication network 110.

As previously described, a query plan of a streaming query may include a set of query primitives. Descriptions of various query primitives—including semantics, event reduction ratio (as such ratios impact the overall data volume expected to be generated by the streaming query plan), intrinsic levels of data parallelism (which may be indicative of the ability to execute the query primitive in parallel on subsets of data), and other characteristics—follow. It is noted that, for at least some query primitives that cannot, by nature, operate on data in parallel, substitution rules may be specified in order to replace such query primitives with semantic equivalents that improve the intra-query parallelism of the query plans in which such query primitives may be used. The query primitives may include functional primitives (e.g., project, filter, map, order, limit, union, aggregation, and join) and flow primitives (e.g., partition, broadcast, and merge), where the flow primitives may be used to enable execution of functional primitives in parallel.

Project Primitive:

In general, a project primitive filters out attributes of received data events if these attributes are not being used in the affected streaming query. The project primitive generates an output event for each input event, retaining only those attributes specified in the output schema of the project primitive. It is noted that, since all other attributes are ignored, the reduction ratio of the project primitive equals b/a, where a is the size of the input schema and b is the size of the output schema. The project primitive can handle input and output events of both cardinality singleton and set. Additionally, as a projection applies to individual tuples (local scope) and does not remember information about incoming data events (stateless), the project primitive can be parallelized without compromising the semantic correctness of a query plan using the project primitive. Thus, the project primitive may be expressed as project(S₁)∪ . . . ∪ project(Sₙ), where S₁, . . . , Sₙ symbolize streams generating data of the same type of data events.

Filter Primitive:

In general, a filter primitive drops any events that do not match a given filter condition, hence implementing WHERE and HAVING clauses. For each input event of cardinality singleton, the filter primitive copies the event from input gate to output gate, if and only if the event matches the given filter predicate(s). For each input event of cardinality set, the filter primitive generates a new event of cardinality set, retaining only those records that match the given filter predicate(s). The reduction ratio of the filter primitive depends on the probability that data events comply with the filter predicate. As the latter results from the actual distribution of the data, this may be hinted within the query plan of the streaming query using the @PASS_RATIO. Additionally, it is noted that, since the semantics of the filter primitive and the project primitive are similar, the filter primitive can also operate in parallel on multiple streams without compromising the semantic correctness of the query plan. Thus, the filter primitive may be expressed as: filter(S₁∪ . . . ∪Sₙ)=filter(S₁)∪ . . . ∪filter(Sₙ).

Map Primitive:

In general, a map primitive executes one or more functions on the attributes of each received data event. The schema of the generated output data represents the results of applying these functions on the attributes of the input schema. Thus, the reduction ratio of the map primitive equals b/a, where a is the size of the input schema and b is the size of the output schema. The map primitive can handle input and output events of both cardinality singleton and set. Additionally, as the map primitive operates stateless on individual data events, the map primitive can operate in parallel on multiple streams without compromising the semantic correctness of the query plan. Accordingly, the map primitive may be expressed as: map(S₁∪ . . . ∪Sₙ)=map(S₁)∪ . . . map(Sₙ).

Order Primitive:

In general, an order primitive takes a set of events as input and produces a new event of cardinality set as output, with the records being sorted according to the specified criteria. The reduction ratio of the order primitive is 1, as all input records are present in their original form in the generated output. However, unlike previously described query primitives, the order primitive typically cannot operate in parallel on multiple streams without compromising the semantic correctness of the query plan (as ordering streams individually will not yield a global ordering of all event streams). In at least some embodiments, however, this limitation may be resolved by applying the following two step ordering substitution: order(S₁ ∪ . . . ∪Sₙ)=order_{merge}(orderₛₜᵣₑₐₘ(S₁), . . . , orderₛₜₑₐₘ(Sₙ)). The orderₛₜᵣₑₐₘ primitive, on a per order basis, orders data events that belong to the same data window in O(nlogn). Next, the order_{merge} primitive merges these individually ordered sets into a globally ordered set in O(n). In contrast to the orderₛₜᵣₑₐₘ primitive, the order_{merge} primitive cannot be executed in parallel. Due to the lower computation complexity of the order_{merge} primitive, however, replacing a single order primitive with this two step ordering substitution improves the overall scalability of a query plan that includes an order clause.

Limit Primitive:

In general, a limit primitive receives a set of data events and produces a new output set, limiting the number of event records in the output set to a given row count. In some cases, an optional offset parameter may be used to specify the number of rows that should be skipped at the beginning of the result set. The reduction ratio of the limit primitive equals rc/s, where rc is the specified row count and s is the size of the received set of data events. Additionally, a limit primitive typically cannot operate in parallel on multiple streams, unless the multiple streams are partitioned on one or more GROUP-BY keys (e.g., explicitly by using the PARTITION ON clause, implicitly via the @PARTITIONED_ON keyword, or the like). However, if the multiple streams are partitioned on one or more GROUP-BY keys, the limit primitive can be parallelized by applying the following substitution: limit(S₁ ∪ . . . ∪Sₙ)=limit(limit(S₁), . . . , limit(Sₙ)). Here, the substitution operates as follows: (1) for each stream, a separate limit primitive reduces the size of the aggregated data events, and (2) the final limit primitive, in turn, reduces the union of these partitioned data sets.

Union Primitive:

In general, a union primitive reads events of multiple input streams and outputs these events, unmodified, onto a single output stream. The reduction ratio of the union primitive equals 1, as all input records are present in their original form in the generated output. It is noted that, although this idempotent union primitive can be deployed in parallel, doing so is not expected to bring any added value to a distributed streaming query deployment.

Group-by Aggregation Primitive:

In general, a group-by aggregation primitive represents the use of an aggregation window to group events according to a given value of a group-by attribute. Events that have the same value for the group-by attribute are put in the same group. The group-by aggregation primitive has one or more aggregation functions associated with it, to calculate one or more values for the group. Examples of aggregation functions include sum, count, maximum, minimum, average, and standard deviation, representations of which follow:

$$sum ( {A}_{1} ⋃ … ⋃ {A}_{n} ) = sum ( sum ( {A}_{1} ) , … , sum ( {A}_{n} ) )$$

$$count ( {A}_{1} ⋃ … ⋃ {A}_{n} = sum ( count ( {A}_{1} ) , … , count ( {A}_{n} ) ) \\ max ( {A}_{1} ⋃ … ⋃ {A}_{n} ) = max ( max ( {A}_{1} ) , … , max ( {A}_{n} ) ) \\ min ( {A}_{1} ⋃ … ⋃ {A}_{n} ) = min ( min ( {A}_{1} ) , … , min ( {A}_{n} ) ) \\ avg ( {A}_{1} ⋃ … ⋃ {A}_{n} ) = \frac{sum ( sum ( {A}_{1} ) , … , sum ( {A}_{n} ) )}{sum ( count ( {A}_{1} ) , … , count ( {A}_{n} ) )}$$

Here, A₁ . . . Aₙ represent the values of the aggregation attributes for events originating from event streams S₁ . . . Sₙ. It is noted that the group-by aggregation primitive is typically used in combination with an output rate limiter which triggers an output event each time the timer expires. For example, the output rate limiter may be specified in the streaming query as “output every x seconds”, “output every y minutes”, or the like. The output event has cardinality set and includes one record for each aggregated group, each record having the aggregated values as columns.

Group-all Aggregation Primitive:

In general, a group-all aggregation primitive, like a group-by aggregation primitive, has one or more aggregation functions associated with it. However, unlike the group-by aggregation primitive, the group-all aggregation primitive puts all events in one single group. The associated aggregation functions calculate values based on all of the events in the associated window. Similarly, as with the group-by aggregation primitive, the group-all aggregation primitive can be associated with an output rate limiter (although the output events will be of cardinality singleton here, since there is only one group to report).

Join Primitive:

In general, a join primitive two or more event streams together. The join primitive has a window associated with each stream being joined. When a new event arrives on any of the join streams, the join primitive tries to match the event with each event in the windows associated with the other streams, according to the given join condition(s). An output event is produced for each combination of matching join conditions in all windows. The output event can include attributes from all joined stream types.

Partition Primitive:

In general, a partition primitive partitions data events based on values of a particular attribute, as specified in the PARTITION ON clause. The partition primitive can handle input and output events of both cardinality singleton and set. The implementation of the partition primitive may execute a Hash Mod function on the values of the given PARTITION ON key, and copy events from the input stream onto the output stream identified by the result of the Hash Mod function. As a result, events with an identical value for the PARTITION ON key will be delivered to the same output stream. Additionally, the partition primitive can operate in parallel on multiple streams without compromising the semantic correctness of the query plan, as the partition primitive operates statelessly on individual data events. Therefore, the following substitution rule may be defined for the partition primitive: partition(S₁∪ . . . ∪Sₙ)=partition(S₁)∪ . . . ∪ partition(Sₙ). The stochastic reduction ratio of the partition primitive highly depends on the actual data distribution. Letting rᵢ represent the reduction ratio of the partition primitive when events are delivered to receiver i, it may be expressed that rᵢ=P(π_{GROUPBYKEY})Vᵢ, which is the probability that an incoming data event is delivered to stream Sᵢ. Here, π_{GROUPBYKEY} represents the GROUP-BY value of a data event and Vᵢ embodies the set of GROUP-BY values that stream i expects to obtain. Thus, it may be seen that the total reduction ratio of the partition primitive may be represented as Σᵢ₋₁ⁿ rᵢ, which equals 1.

Broadcast Primitive:

In general, a broadcast primitive copies events from a single input stream onto each of its output streams. The broadcast primitive can handle input and output events of both cardinality singleton and set. The broadcast primitive may be used to execute sub-queries in parallel. The output events may be annotated with a (“_BROADCAST ID_”) attribute, allowing a downstream merge primitive to deduce which events belong to the same original (i.e. pre-broadcast) event. The broadcast primitive can operate in parallel by nature, such that the following trivial substitution rule can be deduced: broadcast(S₁∪ . . . ∪Sₙ)=broadcast(S₁)∪ . . . ∪broadcast(Sₙ). The reduction ratio of the broadcast primitive equals the amount of output streams each event is copied to, thereby making the broadcast primitive an increase ratio rather than a reduction ratio.

Merge Primitive:

In general, a merge primitive merges multiple events into a single new event. The merge primitive may produce an output event only when all input streams have provided at least one event with the same merge key value. The merge primitive may support a limited number of out-of-order arrivals (e.g., through a configurable “slack” parameter).

It will be appreciated that, although primarily depicted and described with respect to use of a query language including specific query primitives and specific query annotations, the query language supported by SQCS 120 may support various other sets of query primitives or sets of query annotations.

The SQCS 120 may be configured to provide various functions supporting improvement or optimization of streaming queries within communication network 110 (or any other suitable environment). In at least some embodiments, for example, SQCS 120 may be configured may be configured to support improvement or optimization of streaming queries within communication network 110 by one or more of improvements in deployment of a streaming query to communication network 110, improvements in streaming query performance via modification of a streaming query intended for execution within communication network 110 based on measurement data collected from communication network 110, improvements in streaming query performance via integrated deployment and activation of multiple streaming queries sharing a common characteristic, or the like, as well as various combinations thereof. The SQCS 120 may be implemented in any suitable manner for supporting provide various functions supporting improvement or optimization of streaming queries within communication network 110. As depicted in FIG. 1, for example, SQCS 120 may include a processor 121, a memory 122 communicatively connected to the processor 121, and an input-output interface 129 communicatively connected to the processor 121. The processor 121 may be configured to perform various functions supporting improvement or optimization of streaming queries within communication network 110 using various types of information available from memory 122, using various types of interactions with communication network 110 via input-output interface 129, or the like. The memory 122 may store any information suitable for use by processor 121 in providing functions supporting improvement or optimization of streaming queries within communication network 110. As depicted in FIG. 1, for example, memory 122 may store a streaming query control program(s) 123, streaming queries 124, measurement data 125, other information 126, or the like. The streaming query control program(s) 123 may be configured for one or more of improvements in deployment of streaming queries 124 to communication network 110, modification of streaming queries 124 based on measurement data collected from communication network 110, integrated deployment and activation of multiple streaming queries 124 sharing a common characteristic, or the like, as well as various combinations thereof. The various functions which may be provided for improving supporting improvement or optimization of streaming queries within communication network 110, or any other suitable type(s) of environment(s) are described in additional detail below.

The SQCS 120 may be configured to improve or optimize deployment of a streaming query to an environment (illustratively, communication network 110). In at least some embodiments, SQCS 120 may be configured to improve or optimize deployment of a streaming query to an environment by determining a centralized query plan configured to provide a centralized deployment of the streaming query, computing a tree representing a distributed environment in which the streaming query is to be deployed, and determining, based on the centralized query plan and the tree representing the distributed environment in which the streaming query is to be deployed, a distributed query plan configured to provide a distributed deployment of the streaming query within the distributed environment.

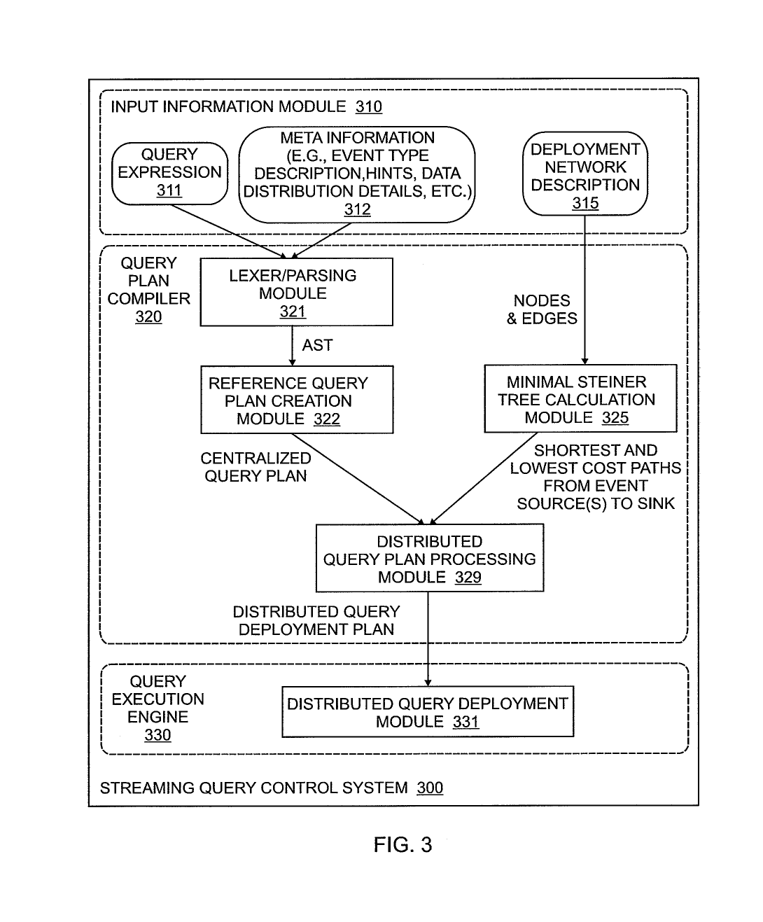

The SQCS 120 may be implemented in various ways for improving or optimizing the deployment of a streaming query to an environment (illustratively, communication network 110). An exemplary implementation of the SQCS 120 for improving or optimizing the deployment of a streaming query to communication network 110 is depicted and described herein with respect to FIG. 3.

FIG. 3 depicts an exemplary embodiment of the SQCS of FIG. 1, illustrating a process for generation of a streaming query and deployment of the streaming query to the communication network of FIG. 1.

The SQCS 300 includes an input information module 310, a query plan compiler 320, and a query execution engine 330. The input information module 310, query plan compiler 320, and query execution engine 330 are configured to perform various steps of the process for generating a streaming query and deploying the streaming query to the communication network 110.

The SQCS 300 is configured to support a process for generation of a streaming query and deployment of the streaming query to the communication network of FIG. 1. The process for generation of a streaming query and deployment of the streaming query may be configured to provide improved or optimized deployment of the streaming query. As depicted in FIG. 3, the process for generation of a streaming query and deployment of the streaming query may be provided as a set of functions performed by input information module 310, query plan compiler 320, and query execution engine 330, as discussed below. The query plan compiler includes a lexer/parsing module 321, a centralized query plan creation module 322, a minimal Steiner tree calculation module 325, and a distributed query plan processing module 329. The query execution engine 330 includes a deployment module 331.

The input information module 310 is configured to obtain various types of input information which may be used for generation of a streaming query and deployment of the streaming query.

The input information obtained by input information module 310 includes a query expression 311 for the streaming query and meta information 312 for the streaming query. The query expression 311 for the streaming query may be a set of query expressions which may be organized by the query plan compiler to form the query plan of the streaming query. The meta information 312 for the streaming query may include one or more of event type description information, hints for use in annotating the query expression (and, thus, the query plan generated based on the query expression), data distribution details, or the like, as well as various combinations thereof. The query expression 311 for the streaming query and at least a portion of meta information 312 for the streaming query (e.g., one or more annotations) may be combined to form an annotated or modified query expression of the streaming query, which is then provided to query plan complier 320. It is noted that modification of the query expression 311 based on at least a portion of the meta information 312 is optional, and, thus, that the query expression 311 may be provided to query plan complier 320 without modification. As depicted in FIG. 3, the query expression 311 (original or modified) is provided to the lexer/parsing function 321 of query plan compiler 320, and, optionally, at least a portion of the meta information 312 also may be provided to the lexer/parsing function 321 of query plan compiler 320.

The input information obtained by input information module 310 also includes a deployment network description 315 for the environment for which the streaming query is to be generated and deployed (namely, communication network 110). The deployment network description 315 includes a description of the topology of communication network 110, which may include identification of the nodes of communication network 110, identification of the edges of the communication network 110, indications of the manner in which the nodes and edges are connected to form the network topology of the communication network 110. The deployment network description 315 also may include one or more of identification of nodes suitable for use as processing nodes which may implement portions of the streaming query, indications of processing capabilities of nodes, indications of potential or actual capacities of the edges, or the like, as well as various combinations thereof. The deployment network description 315 may be a weighted directed network graph representing the targeted distributed execution environment (namely, communication network 110) using (1) vertices, where the vertices represent the source nodes (e.g., generating raw data events), processing nodes on which query primitives of the query plan may be deployed (namely, processing nodes 112), and the sink node (e.g., at which the query results of the streaming query are collected) and (2) edges, where the edges represent available network links or paths between vertices and, further where the edges have associated therewith respective weights which quantify the costs of using the network links or paths, respectively. The deployment network description 315 may be entered manually by a user, discovered from the deployment network automatically, obtained from one or more management systems providing management functions for the deployment network, or the like, as well as various combinations thereof. As depicted in FIG. 3, the deployment network description 315 is provided to the minimal Steiner tree calculation module 325 of query plan compiler 320.

The input information obtained by input information module 310 may be received via one or more user interfaces (e.g., entered by one or more users of SQCS 300, obtained from local memory of SQCS 300, received at SQCS from one or more remote systems (e.g., receiving the deployment network description 315 from a network topology system associated with the communication network 110), or the like, as well as various combinations thereof. The input information is provided from input information module 310 to query plan compiler 320.

The lexer/parsing function 321 of query plan compiler 320 receives the query expression 311 (e.g., the original query expression 311 or a modified version of query expression 311), and, optionally, at least a portion of meta information 312, from input information module 310. The lexer/parsing function 321 is configured to process the query expression 311 in a manner for creating an associated abstract syntax tree (AST) for query expression 311, and to provide the AST for query expression 311 to centralized query plan creation module 322. The processing of the query expression 311 by lexer/parsing function 321 may include parsing of the query expression 311 for verification of the syntactic and semantic correctness of the query expression 311).

The centralized query plan creation module 322 receives the AST for query expression 311 from lexer/parsing function 321. The centralized query plan creation module 322 processes the AST for query expression 311 to generate a centralized query plan for query expression 311. The centralized query plan for query expression 311 defines an optimal query execution graph for a centralized deployment of the streaming query (e.g., for a centralized streaming query execution environment, such as on a single processing node, on a centralized cluster or datacenter, or the like). The centralized query plan creation module 322 provides the centralized query plan for query expression 311 to distribute query plan processing module 329. The query plan compiler 320 is configured to compute a bandwidth-optimized query plan for a distributed deployment of the streaming query (e.g., for a distributed streaming query execution environment, such as distributed across a set of processing nodes 112 of communication network 110) based on the optimal query execution graph for a centralized deployment of the streaming query and the deployment network description 315, as discussed in additional detail below.

The minimal Steiner tree calculation module 325 of query plan compiler 320 receives the deployment network description 315 from input information module 310. As noted above, deployment network description 315 may be a weighted directed network graph representing the targeted distributed execution environment (namely, communication network 110) using vertices and edges. The minimal Steiner tree calculation module 325 is configured to process the deployment network description 315 to generate a minimal Steiner tree for the deployment network for the streaming query. The minimal Steiner tree includes a set of shortest and lowest cost paths from event sources of the streaming query to the sink of the streaming query. Here, the cost may be based on any suitable metric (e.g., bandwidth consumption, monetary cost of using the path, or the like, as well as various combinations thereof. The minimal Steiner tree includes the source nodes and the sink node as terminal vertices. The minimal Steiner tree includes the shortest and lowest cost paths from the weighted directed network graph specified by deployment network description 315, where each of the paths begins at one of the source nodes and ends at the sink node. It will be appreciated that a property of Steiner trees is that many path segments may be common. The minimal Steiner tree calculation module 325 provides the minimal Steiner tree to the distributed query plan processing module 329. It will be appreciated that, although primarily depicted and described with respect to use of a minimal Steiner tree, any other suitable tree-based representation of the distributed execution environment may be used (e.g., a tree including shortest path paths, a tree including shortest and least cost paths, or the like).

The distributed query plan processing module 329 receives the centralized query plan for query expression 311 and the minimal Steiner tree for the deployment network for the streaming query.

The distributed query plan processing module 329 generates a distributed query plan for query expression 311 based on the centralized query plan for query expression 311 and the minimal Steiner tree for the deployment network for the streaming query. The distributed query plan processing module 329 maps the query primitives of the centralized query plan onto the vertices of the minimal Steiner tree to form the distributed query plan. The distributed query plan processing module 329 may map the query primitives of the centralized query plan onto the vertices of the minimal Steiner tree in a manner for minimizing the cost metric upon which the minimal Steiner tree is based (e.g., bandwidth consumption, monetary cost, or any other suitable metric, as discussed above). In general, a given query primitive of the centralized query plan may be mapped onto one vertex of the minimal Steiner tree, onto multiple vertices of the minimal Steiner tree as multiple instances of the given query primitive (e.g., so that the multiple instances of the given query primitive may be running in parallel), or the like. In at least some embodiments, mapping of the query primitives of the centralized query plan onto the vertices of the minimal Steiner tree in a manner for minimizing cost may include deploying various primitives of the centralized query plan as close to each other as possible, as close to the source node(s) as possible, or the like, as well as various combinations thereof. It will be appreciated that the ability to deploy query primitives in this manner may depend on the degree of intra-query parallelism of the centralized query plan, where intra-query parallelism may represent the ability to execute separate stages of a reference query plan in a clustered fashion (parallelism), the ability to distribute consecutive query stages over different workers (query sharding), or the like. In at least some embodiments, mapping of the query primitives of the centralized query plan onto the vertices of the minimal Steiner tree in a manner for minimizing cost may include using one or more substitution rules (e.g., from a set of substitution rules available to the query plan compiler 320) to replace query primitives of the centralized query plan with one or more semantic equivalents that improve the resulting degree of intra-query parallelism. Thus, the distributed query plan for query expression 311 also may be considered to be a cost-optimized query plan tailored for distributed deployment.

The distributed query plan processing module 329 generates a distributed query deployment plan for query expression 311 based on the distributed query plan for query expression 311. The distributed query deployment plan maps the query primitives of the distributed query plan onto the processing nodes 112 of communication network 110 on which the query primitives are to be deployed and executed. Thus, the distributed query plan processing module 329 may generate the distributed query plan by rewriting the centralized query plan based on the deployment network for the streaming query, so as to enable minimization of the cost of the composed query deployment plan of the streaming query that is generated from the distributed query plan. The distributed query deployment plan may be represented in the form of a set of configuration information, a script or set of scripts, or the like, as well as various combinations thereof. The distributed query plan processing module 329 provides the distributed query deployment plan to the query execution engine 330.

The query execution engine 330 receives the distributed query deployment plan from query plan compiler 320. The query execution engine 330 processes the distributed query deployment plan in order to deploy, connect, and activate the runtime equivalents of the query primitives of the distributed query plan on the set of processing nodes to which the query primitives were mapped in the distributed query distribution plan. It is noted that, in SQCS 300, the compilation of the distributed query plan by query plan compiler 320 has been fully decoupled from deployment of the distributed query plan to communication network by query execution engine 330, thereby enabling execution of the distributed query deployment plan on various runtimes (e.g., STORM, AKKA, or any other suitable runtime environment supporting deployment of streaming queries), as long as the various runtimes offer the query execution functionalities represented by the query primitives in the distributed query deployment plan.

It will be appreciated that, although primarily depicted and described with respect to use of a minimal Steiner tree to determine the distributed query plan for a streaming query, in at least some embodiments, as discussed in additional detail below, any other suitable tree-based representation of the distributed execution environment for the streaming query may be used to generate the distributed query plan for the streaming query (e.g., a shortest path tree, a shortest path and lowest cost tree in a form other than a minimal Steiner tree, or the like).

It will be appreciated that, although primarily depicted and described with respect to a specific implementation of SQCS 120 that is configured for generating a distributed query plan and deploying the distributed query plan to the communication network 110, the SQCS 120 may be configured in various other ways for generating a distributed query plan and deploying the distributed query plan to the communication network 110 (e.g., using different mappings of the described steps of the process to modules of SQCS 120, using mapping of the described steps of the process to different modules of SQCS 120, or the like, as well as various combinations thereof).

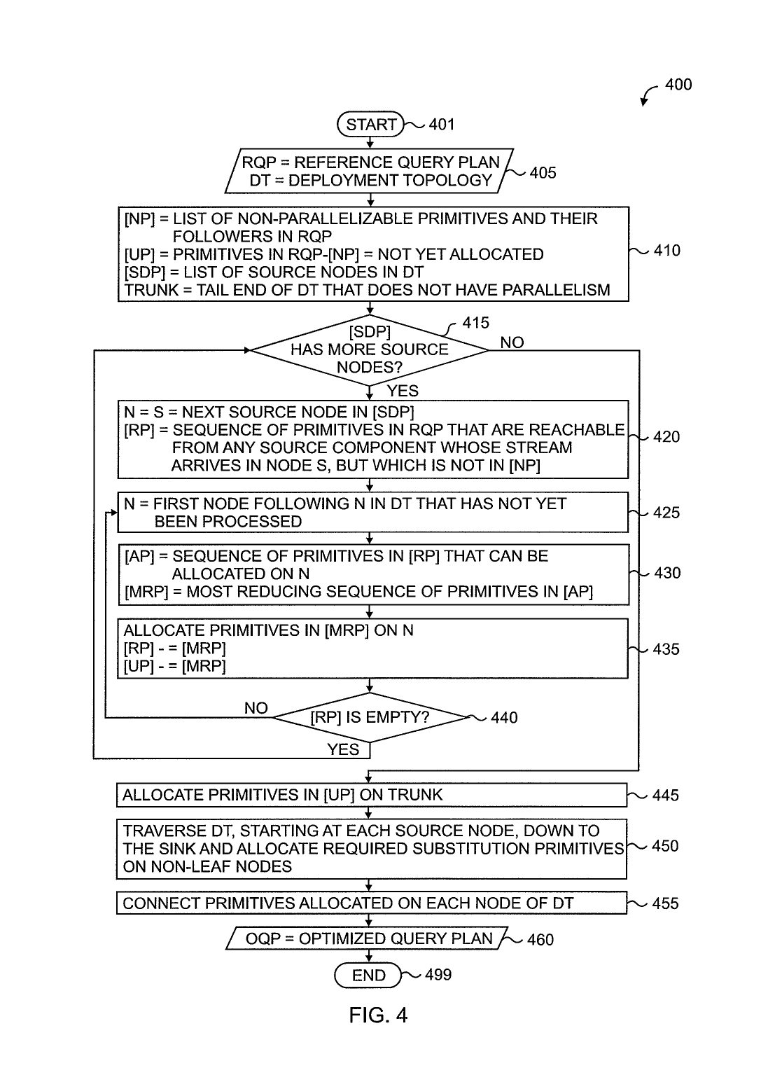

FIG. 4 depicts one embodiment of a process for generating a distributed query plan for a streaming query based on a centralized query plan for the streaming query and a deployment topology description of an environment in which the streaming query is to be deployed. It will be appreciated that portions of method 400 of FIG. 4 may be performed by query plan compiler 320 (e.g., by minimal Steiner tree calculation module 325 and distributed query plan processing module 329). It will be appreciated that, although primarily depicted and described as being performed serially, at least a portion of the steps of method 400 may be performed contemporaneously or in a different order than depicted in FIG. 4.

At step 401, method 400 begins.

At step 405, a Reference Query Plan (RQP) and a Deployment Topology (DT) are received. The RQP is a centralized query plan for the streaming query (e.g., such as the centralized query plan described as being created by reference query plan creation module 322 of query plan compiler 320 of FIG. 3). The RQP may be provided in the form of an AST, or in any other suitable manner for representing a centralized query plan. The DT is a description of the deployment topology of the environment in which the streaming query is to be deployed (e.g., such as the deployment network description 315 provided by input information module 310 to the minimal Steiner tree calculation module 325 of query plan compiler 320 of FIG. 3).

At step 410, a set of information is determined. A list of non-parallelizable query primitives, and the followers of the non-parallelizable query primitives, in the RQP is determined (denoted as [NP]). A list of the query primitives not yet allocated (e.g., each query primitive in RQP excluding any query primitives list in [NP] (i.e., RQP-[NP]) is determined (denoted as [UP]). A list of source nodes in the DT is determined (denoted as [SDP]). A tail end of the DT that does not have parallelism is determined (denoted as TRUNK). It is noted that, since the non-parallelizable query primitives of [NP] cannot be executed on different branches of the deployment tree of the streaming query in parallel, the non-parallelizable query primitives of [NP] may only be allocated on the tree trunk of the deployment tree of the streaming query, which is defined as the tail end of the deployment tree that only has a single path towards the sink of the deployment tree.

In steps 415-440, the deployment tree of the streaming query is traversed. The deployment tree of the streaming query is traversed starting at each source node down to the sink node.

At step 415, a determination is made as to whether [SDP] includes more source nodes. It is expected that the answer will be YES at least on the first pass through this portion of method 400. If a determination is made that the [SDP] does not include more source nodes, method 400 proceeds to step 445. If a determination is made that the [SDP] does include more source nodes, method 400 proceeds to step 420.

At step 420, the next source node in the [SDP] is determined (denoted as N or S), and a sequence of primitives in the RQP that are reachable from any source component whose stream arrives in node S (but which is not in [NP]) is determined (denoted as reachable query primitives, or [RP]). In other words, for each source node, a determination is made as to which streams arrive at that source node and, for each such stream that arrives at that source node, which query primitives that stream runs through in the RQP.

At step 425, N is updated to correspond to a first node following N (i.e., the existing N) in the DT that has not yet been processed.

At step 430, a sequence of query primitives in [RP] that can be allocated on N is determined (denoted as allocable query primitives, or [AP]) and a most reducing sequence of query primitives in [AP] is determined (denoted as most reducing query primitives, or [MRP]). The [AP] is the subset of [RP] that may be allocated on the current node N. In case of a JOIN primitive for example, the JOIN primitive can be parallelizable, but can typically only run on a node through which all required input streams flow. The [MRP] is the sequence of query primitives for which the ratio between the size of the event stream (e.g., in bytes) exiting the last query primitive and the event stream size coming into the first query primitive, is minimal. The [MRP] includes a sequence of query primitives that should be deployed as soon as possible (e.g., as close to the event source(s) as possible), since this is the most optimal choice of deployment in order to minimize overall bandwidth consumption throughout the deployment tree.

At step 435, the query primitives in [MRP] are allocated on N, [RP] is updated based on [MRP] (e.g. [RP]−=[MRP]), and [UP] is updated based on [MRP] (e.g. [UP]−=[MRP]).

At step 440, a determination is made as to whether [RP] is empty. If a determination is made that [RP] is not empty, method 400 returns to step 425 (e.g., as long as there are reachable query primitives that have not yet been allocated, the next node in the deployment tree is selected to become the current node and the same procedure is run). If a determination is made that [RP] is empty, method 400 returns to step 415 (e.g., the procedure may be run again based on a new source node as long as at least one source node remains).

At step 445, the query primitives in [UP] are allocated on TRUNK. The allocation of the query primitives of [UP] on TRUNK may be performed by allocating query primitives of [UP] that reduce the event stream the most as soon as possible on TRUNK (e.g., as close to the source node as possible) and allocating the remaining query primitives of [UP] as late as possible (e.g., as close to the sink node as possible).

At step 450, the DT is traversed, starting at each source node down to the sink node, and any required substitution primitives are allocated on non-leaf nodes. This may include a determination as to which substitution primitives are to be allocated on downstream nodes in order to assure semantic equivalence with the RQP. It is noted that, in at least some cases, only non-leaf nodes and non-trunk nodes (except the first node) may have substitution primitives allocated thereon.

At step 455, query primitives allocated on each node of the DT are connected. This may include definition of the edges in the DAG of the distributed query plan. This may include determining the correct query primitive sequence and the schema of respective input and output streams of each query primitive.

At step 460, the distributed query plan (e.g., such as the distributed query plan determined by the distributed query plan processing module 329 of query plan compiler 320 of FIG. 3) is output.

At step 499, method 400 ends.

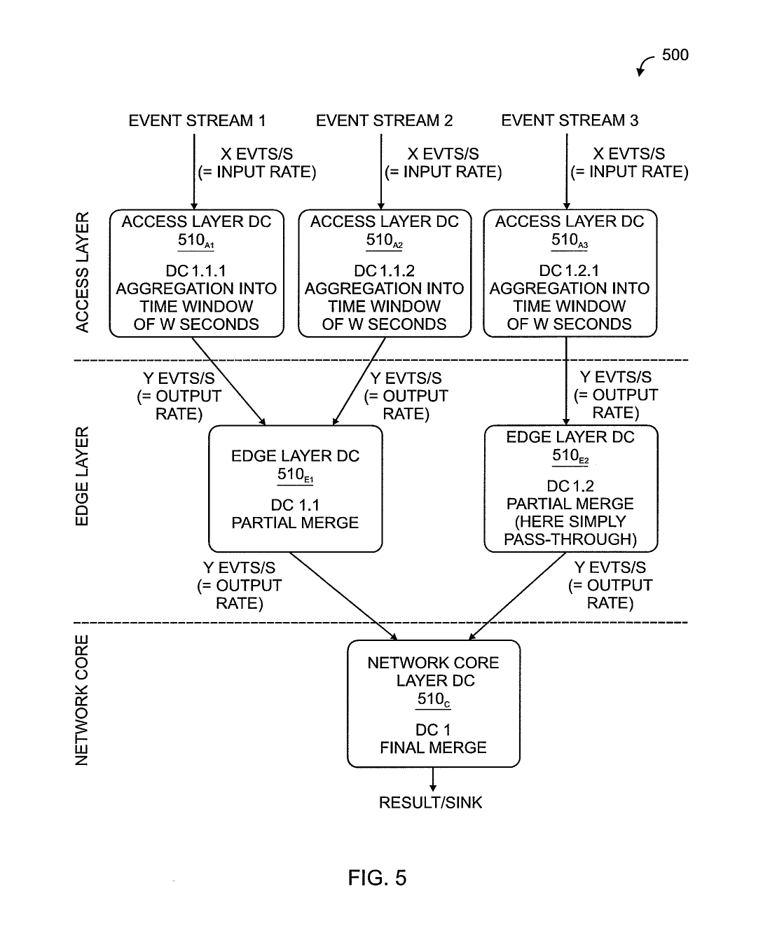

The improvement or optimization of deployment of a streaming query to an environment may be better understood by considering an exemplary use case in which an exemplary streaming query is to be deployed to an exemplary communication network. More specifically, the streaming query is a top-N streaming query configured to determine the top 10 HTTP hosts based on download footprint and the exemplary communication network is a communication network including a distributed cloud environment It is noted that multiple strategies for execution may be utilized depending on properties of the event stream. In this use case, it is assumed that a set of probes are placed strategically throughout the network (e.g., at the access layer) in order to gather information on the number of bytes downloaded from each website by users of the communication network. As a result, each probe produces an event stream at an average rate of x events per second. In this use case, it also is assumed that processing nodes available for hosting portions of the streaming query are available at various layers of the communication network (e.g., at the access layer, the edge layer, and within the core network). An exemplary communication network configured for the top-N streaming query use case is depicted in FIG. 5.

FIG. 5 depicts an exemplary communication network configured for a top-N streaming query use case.

As depicted in FIG. 5, the communication network 500 includes three access layer DCs 510_{A1}-510_{A3} (collectively, access layer DCs 510_{A}, which also are marked as DC 1.1.1, DC 1.1.2, and DC 1.2.1, respectively) in the access layer, two edge layer DCs 510_{E1}-510_{E2} (collectively, edge layer DCs 510_{E}, which also are marked as DC 1.1 and DC 1.2, respectively) in the edge layer, and a single, central network core layer DC 510_{C} (which also is marked as DC 1) in the network core layer.

As depicted in FIG. 5, each access layer DC 510_{A} (1) consumes a separate event stream (illustratively, Event Stream 1 (ES1), Event Stream 2 (ES2), and Event Stream 3 (ES3), respectively) including information from local probes in their own coverage area and (2) maintains a sliding time window of w seconds, aggregating download byte counts per location. Additionally, a top-N streaming query runs continuously on these sliding time windows to produce a top-N result at a fixed (configurable) output rate of y events per second.

As depicted in FIG. 5, each edge layer DC 510_{E} is configured to merge the top-N result streams from the access layer DCs 510_{A} in its associated area of responsibility, thereby producing a new stream of top-N results toward the network core layer DC 510_{C}. It is noted that the output rate of the edge layer DCs 510_{E} is approximately the same as the input rate of the edge layer DC 510_{E}. For example, each edge layer DC 510_{E}. simply awaits a report from each access layer DC 510_{A} before merging the report and immediately sending out the results toward the network core layer DC 510_{C}.

As depicted in FIG. 5, the network core layer DC 510_{C} produces the final result of the top-N query by again merging the partially merged top-N streams produced by the edge layers DC 510_{E}. The output rate of the final result of the top-N query is approximately y events per second.

There are situations in which it may be more efficient to process event streams centrally and situations in which it may be more efficient to process event streams in a distributed fashion rather than centrally. The evaluation of such situations, as indicated above, may be performed based on bandwidth consumption criterion. In the case of distributed execution, multiple strategies can be chosen depending on whether or not the event streams are implicitly partitioned on the group-by field (as in the example above). Here, a set of event streams may be considered to be partitioned (on the group-by field) if each event stream in the set of event streams has a mutually exclusive set of possible values for that group-by field. Accordingly, the following three distributed execution cases may be considered and evaluated: implicitly partitioned streams, un-partitioned streams, and explicitly partitioned streams. However, before describing these three distributed execution cases, it is noted that, since communication network 500 is a hierarchically arranged telco-type network, the overall bandwidth consumption may be expressed as B=B_{edge}+B_{core}, or, in other words, the sum of the bandwidth consumption in the edge layer (i.e., the sum of bandwidth consumed between each access layer DC 510_{A} and its associated downstream edge layer DC 510_{E}) and the network core layer (i.e., between each edge layer DC 510_{E} and the network core layer DC 510_{C} produces in the network core layer). Additionally, it is noted that, as compared with the bandwidth of the edge layer, the bandwidth of the network core layer is expected to be relatively expensive. Additionally, for purposes of clarity in comparing the centralized execution case and the three distributed execution cases, the bandwidth will be expressed as the number of events per second (so as to cancel out the actual event size).

Centralized Case:

In this case, each event stream is sent to a central DC, where the top-N algorithm runs. The amount of information sent across the network toward this central DC may be calculated as: B_{edge}=B_{core}=ax, such that B_{central}=2ₐₓ where a is the number of mobile-flow event streams in the network and X is the rate at which events are being produced by each probe.

Distributed Case—

Implicitly Partitioned Streams: In this case, if the GROUP-BY field values are mutually exclusive per stream (such as for grouping by location), each access layer DCs 510_{A} could simply calculate its top-N locally and only report these top-N results to the edge layer at each output moment (e.g., frequency y). The edge-layer merging performed by each edge layer DC 510_{E} could then be implemented by simply picking the top n values out of the a*n values being reported to the respective edge layer DC 510_{E}, where a is the number of access layer DCs 510_{A} connected to the respective edge layer DC 510_{E}. In this case, bandwidth consumption may be expressed using B_{edge}=any and B_{core}=eny, such that the total bandwidth consumption may be expressed as B_{implicit}=any+eny=(a+e)ny, where a is the number of mobile-flow event streams in the communication network, e is the number of edge layer DCs 510_{E}, n is the value of N in top-N, and y is the chosen output frequency of top-N calculations. Thus, distributed execution in the case of implicitly partitioned streams may become interesting as soon as B_{implicit}<B_{central} [symbol] [(a+e)/2a]ny<x.

As an example, consider a communication network serving 100M users, having one access layer DC 510_{A} per 100K users, and having one edge layer DC 510_{E} for every 50 access layer DCs 510_{A}. This translates into a=1000 and e=20. Thus, a Top-20 calculation would beneficially be done in a distributed fashion as soon as the event arrival rate reaches at least x=11 events per second.

Distributed Case—

Un-Partitioned Streams: In this case, the streams being processed are un-partitioned (i.e., not implicitly or explicitly partitioned). For example, in the specific use case of grouping by HTTP host (as well as various other use cases), a mutually exclusive set of hosts per stream is not available. Accordingly, it becomes necessary to report the entire set of “download volumes by host” to the next network layer at each output moment, and the merging algorithm at the next network layer needs to sum the download volumes per host and then calculate the new n highest values. The bandwidth consumption will suffer dramatically if the number of different GROUP-BY values is large or, in other words, when the selectivity (defined below) of the stream is low. The bandwidth consumption for the un-partitioned case may be expressed using B_{edge}=aTₘy and B_{core}=eTₘy such that the total bandwidth consumption for the un-partitioned case may be expressed as: B_{unpartitioned}=aTₘy=eTₘy=(a+e)Tₘy, where a, e and y are as defined as in the distributed case for implicitly partitioned streams, and, further, where Tₘ is a function which expresses the amount of aggregation slots that are occupied in a time window when m events have arrived since the window was opened. In order to calculate Tₘ, let pₘ^{dup} represent the chance that the m^{th} event arriving in the window W has a duplicate value for the aggregation key (i.e., an event that can successfully be aggregated with another event already in the window, and hence will not consume an additional aggregation slot in the window). For ∀m≧1, this chance can be expressed as Pₘ^{dup}=sTₘ₋₁, where s is the selectivity factor of the GROUP-BY field in the stream and may be defined as the inverse of the amount of possible distinct values for the aggregation key(s) in the event stream, so that s=1/S, where S is the set of possible values for the aggregation key and an assumption is made that there is an equal distribution of the GROUP-BY values. Thus, it follows that:

$${T}_{m} = {T}_{m - 1} + ( 1 - {P}_{m}^{dup} ) ⇒ {T}_{m} = 1 + ( 1 - s ) {T}_{m - 1} \\ ⇒ {T}_{m} {\sum }_{i = 0}^{m - 1} {( 1 - s )}^{i} = [ 1 - {( 1 - s )}^{m} ] / s .$$

As a bounding condition, T₀=0. Additionally, it is noted that

$${T}_{m} {\sum }_{i = 0}^{m - 1} {( 1 - s )}^{i} = [ 1 - {( 1 - s )}^{m} ] / s$$

is also known as the Birthday problem, and that Tₘ≦5 min(m, (1/s)). In case of a sliding time window, m=xw, with x being the event arrival rate and w being the window size in seconds, since it is expected that only at the start of the stream would the time window start off empty (ignoring any startup effect, as evaluation of the cases is more well suited to use of sustained bandwidth measurements). Thus, total bandwidth consumption for the un-partitioned case may be expressed as: B_{unpartitioned}=(a+e)[(1−(1−s)^{xw})/s]y. In the general case, distributed execution becomes interesting when B_{unpartitioned}<B_{central} [symbol] [((a+e)(1−(1−s)^{xw}))/2as]y<x. This equation may be simplified by considering the worst case bandwidth consumption in the distributed case, which is reached when Tₘ=(1/s). This worst case will be reached for sufficiently large xw>>(1/s) (i.e., either for sufficiently large input rate or sufficiently large time window). Then, substituting this worst case value for Tₘ in (2), the total bandwidth consumption for the un-partitioned case may then be expressed as B_{unpartitioned}≦[((a+e)y)/s]. Accordingly, distributed execution of un-partitioned streams is beneficial in terms of bandwidth consumption as soon as x>[(a+e)/2as]y. As an example, again consider a communication network serving 100M users, having one access layer DC 510_{A} per 100K users, and having one edge layer DC 510_{E} for every 50 access layer DCs 510_{A}. This translates into a=1000 and e=20. Additionally, assume a selectivity factor of s=1/1000. Thus, a Top-20 calculation using non-mutually exclusive distributed event processing would beneficially be done in a distributed fashion as soon as the event arrival rate reaches at least x=500 events per second.

Distributed Case—Explicitly Partitioned Streams:

In this case, the event streams that are being processed are explicitly partitioned prior to processing of the event streams. It is noted that, given that partitioned streams may be processed much more efficiently than un-partitioned streams in a distributed setting, it may be beneficial to explicitly partition streams before processing the streams. For example, this strategy could be beneficial for those use cases in which only a marginal amount of events arrive at the “wrong” DC, (e.g., partitioning on user ID in a roaming scenario). The explicit partitioning of streams in this manner may be achieved by putting a partitioning component at each access node before the processing component. However, given the hierarchical network topology of communication network 500, an assumption that direct communication links exist between each of the access layer DCs 510_{A} may not be made; rather, it is to be assumed that communication between two access layer DCs 510_{A} must traverse one or more layers up the hierarchy (e.g., depending on whether the two access layer DCs 510_{A} are connected to a common edge layer DC 510_{E}). For example, communication from DC1.1.2 to DC1.1.1 may need to follow the physical path DC1.1.2→DC1.1→DC1.1.1. Similarly, for example, communication from DC1.2.1 to DC1.1.1 may need to follow the physical path DC1.2.1→DC1.2→DC1→DC1.1→DC1.1.1. In other words, there may be cases in which the overhead of explicit partitioning can quickly outweigh the potential benefits of explicit partitioning. In order to calculate the bandwidth consumption for this case, let f represent the percentage of events that arrive at the correct access layer DC 510_{A} (i.e., at the access layer DC 510_{A} that is chosen to be responsible for processing each of the events having the key value of that event). In case of an equal distribution of key values across each of the DCs 510, f would be equal to 1/a. The mutually-exclusive case corresponds to f=1. It is expected that f should be much higher than 1/a in order for this strategy to be beneficial. Given the above definition for f, the total amount of events that arrive at the correct access layer DC 510_{A} is given by aft, while the total amount of outlier events (i.e., those events that arrive at the wrong access layer DC 510_{A}) in the network is given by a(1−f)x. Thus, the additional bandwidth consumption in the edge layer due to explicit partitioning may be expressed as B_{edge}^{extra}: =2a(1−f)ₓ (i.e., once from the originating access layer DC 510_{A} to the edge layer DC 510_{E} and once from the edge layer DC 510_{E} to the responsible access layer DC 510_{A}). Additionally, assuming a hierarchical network in a perfectly balanced tree structure where there is a total of a access layer DCs 510_{A} and a total of e edge layer DCs 510_{E}, the extra bandwidth consumption in the network core layer due to explicit partitioning corresponds to the total amount of outlier events arriving in an access layer DC 510_{A} that is not linked to the same edge layer DC 510_{E} as the access layer DC 510_{A} that is responsible for the outlier events, which can be expressed as B_{core}^{extra}=2(e−1)(a/e)(1−f)ₓ(i.e., again, once downstream core from the originating edge layer DC 510_{E} to the network core DC 510_{C} and once upstream from the network core DC 510_{C} to the responsible edge layer DC 510_{E}). Thus, the total bandwidth consumption in the case of explicit partitioning may be expressed as B_{explicit}=B_{implicit}+B_{edge}^{extra}+B_{core}^{extra}==(a+e)ny+2a(1−f)(2−(1/e))x. As an example, again consider a communication network serving 100M users, having one access layer DC 510_{A} per 100K users, and having one edge layer DC 510_{E} for every 50 access layer DCs 510_{A}. This translates into a=1000 and e=20. Additionally, assume that y=1, n=20, s=1/1000, and f=1/a (i.e., equal distribution). Thus, a Top-20 calculation using explicit partitioning would beneficially be done in a distributed fashion as long as the event arrival rate is x<256 events per second. Additionally, it has been determined that the threshold event arrival rate of explicit partitioning for this example changes with changes in s as follows: for s=1/2000, x<517; for s=1/10000, x<2610; (3) and so forth. Similarly, it has been determined that the threshold event arrival rate of explicit partitioning for this example changes with changes in n as follows: for n=10, x<258; for n=100, x<235; for n=500, x<130; and so forth.

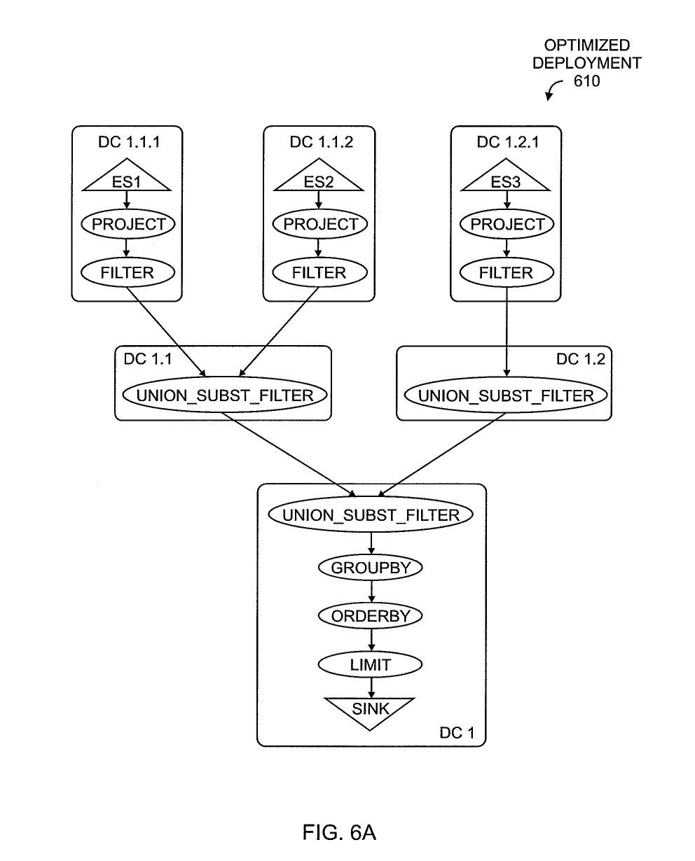

FIGS. 6A and 6B depict exemplary optimized deployments of a top-N streaming query on the exemplary communication network of FIG. 5. The top-N query that is considered is the exemplary top-N query for determining the top N HTTP hosts based on download footprint. Here, the DCs 510 correspond to processing nodes on which the different query primitives of the query plan of the top-N streaming query may be deployed, although it will be appreciated that the DCs 510 each may include respective sets of processing nodes (e.g., VMs, servers, or the like) on which query primitives of the query plan of the top-N streaming query may be deployed.

FIG. 6A depicts an exemplary optimized deployment of the top-N streaming query on the exemplary communication network of FIG. 5 in the absence of hints. As depicted in the optimized deployment 610 of FIG. 6A, the different query primitives of the query plan of the top-N streaming query are deployed in a hierarchical way, both in terms of the hierarchical level of the communication network at which they are deployed (e.g., access layer DCs 510_{A} versus edge layer DCs 510_{E} versus network core layer DC 510_{C}) as well as the arrangement of query primitives within the DCs 510. In optimized deployment 610, the PROJECT and FILTER query primitives are deployed as close as possible to the event sources, since these query primitives reduce the event streams and are fully parallelizable. By contrast, in optimized deployment 610, given that the GROUP-BY primitive is not parallelizable in a general way and may not be executed in parallel since it is not known whether or not the input streams are partitioned, the GROUP-BY primitive is deployed in the same processing node (i.e., network core DC 510_{C}) as the SINK node. Additionally, the intermediate processing nodes (illustratively, edge layer DCs 510_{E}) and the sink processing node (illustratively, network core DC 510_{C}) include UNION primitives configured to route events from multiple input streams into a single output stream (although it will be appreciated that the UNION primitive on the edge layer DC 510_{E2} is essentially a pass-through function as it only receives a single input stream).

FIG. 6B depicts an exemplary optimized deployment of the top-N streaming query on the exemplary communication network of FIG. 5 when partitioned-on hints are used. As depicted in the optimized deployment 620 of FIG. 6B, the different query primitives of the query plan of the top-N streaming query are deployed in a hierarchical way, both in terms of the hierarchical level of the communication network at which they are deployed (e.g., access layer DCs 510_{A} versus edge layer DCs 510_{E} versus network core layer DC 510_{C}) as well as the arrangement of query primitives within the DCs 510. Here, the partitioned-on hint is used for the top-N streaming query (annotated as @PARTITIONED_ON=[http_host]), which, as described above, is indicative that the GROUP-BY, ORDER-BY, and LIMIT query primitives may now be executed in parallel. As a result, in optimized deployment 620, each of the access layer DCs 510A includes the following ordering of query primitives: PROJECT→FILTER→GROUP-BY→ORDER-BY→LIMIT. However, due to parallelization of the GROUP-BY, ORDER-BY, and LIMIT query primitives, the streaming query plan specifies insertion of corresponding substitution primitives (namely, substitution primitives for the GROUP-BY, ORDER-BY, and LIMIT query primitives) on the intermediate processing nodes (illustratively, edge layer DCs 510_{E}) and the sink processing node (illustratively, network core DC 510_{C}) of the deployment tree. Additionally, it is noted that the GROUP-BY query primitive indicates that the GROUP-BY query primitive is to be followed by a MERGE substitution primitive configured to merge similar groups and, further, that since such merging may affect the ordering, the MERGE substitution primitive indicates that the MERGE substitution primitive is to be followed by an ORDER-BY substitution primitive and a LIMIT substation primitive.

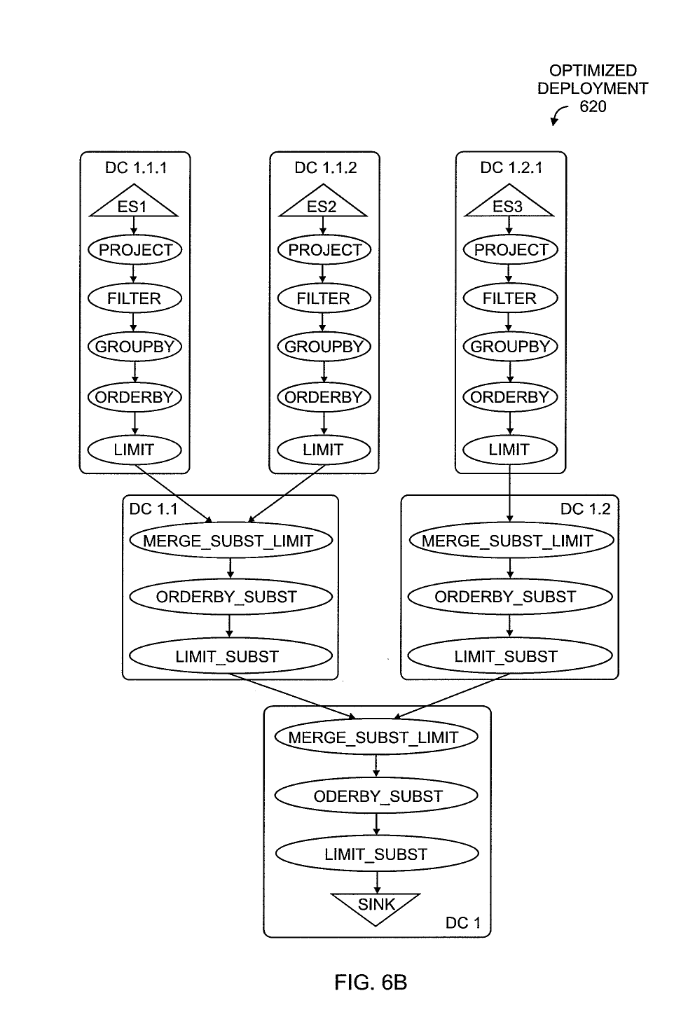

As discussed above, the SQCS 120 may be implemented in various ways for improving or optimizing the deployment of a streaming query to an environment. Accordingly, a more general embodiment of a method for improving or optimizing the deployment of a streaming query to an environment, which may be applicable to various such implementations of SQCS 120, is depicted and described with respect to FIG. 7.

FIG. 7 depicts an exemplary embodiment of a method for determining, deploying, and activating a streaming query within a distributed environment. It will be appreciated that, as depicted in FIG. 7, at least a portion of the steps of method 700 may be performed simultaneously or contemporaneously. It also will be appreciated that portions of the steps of method 700 depicted as being performed contemporaneously may be performed serially, and that at least some steps of method 700 may be performed in a different order than depicted in FIG. 7.

At step 701, method 700 begins.

At step 710, a centralized query plan is determined for the streaming query plan. The centralized query plan is configured for a centralized deployment of the streaming query.

In at least some embodiments, as depicted in FIG. 7, in at least some embodiments, step 710 of method 700 may be implemented using steps of determining a query expression for the streaming query (step 721), determining an AST for the streaming query based on the query expression for the streaming query (step 712), and determining the centralized query plan for the streaming query based on the AST for the streaming query (step 713). It is noted that at least some embodiments of these steps may be better understood by way of reference to FIG. 3.

In at least some embodiments, the centralized query plan may have already been created, such that determining the centralized query plan for the streaming query may simply include retrieval of the centralized query plan from storage.

At step 720, a tree representation of the distributed environment is determined.

In at least some embodiments, as depicted in FIG. 7, step 720 of method 700 may be implemented using steps of receiving a description of the distributed environment (step 731) and determining the tree representation of the distributed environment based on the description of the distributed environment (step 732). It is noted that at least some embodiments of these steps may be better understood by way of reference to FIG. 3.

The description of the distributed environment may include a description of the processing nodes of the distributed environment and the edges connecting the processing nodes of the distributed environment. The edges connecting the processing nodes of the distributed environment may have weights associated therewith, which may be determined based on one or more cost metrics which may be used as the basis for determination of the shortest paths or shortest and lowest cost paths of the tree representation of the distributed environment, as discussed below.

The tree representation of the distributed environment may include a set of vertices representing processing nodes of the distributed environment and a set of edges representing communication paths between pairs of processing nodes of the distributed environment. The tree representation of the distributed environment also may include one or more source nodes representing one or more sources of events to which the streaming query may be applied and a sink node representing an output to which results of the streaming query may be sent. The tree representation of the distributed environment may be a shortest path tree including a set of shortest communication paths from the one or more source nodes to the sink node. The tree representation of the distributed environment may be a shortest path and lowest cost tree, where any suitable cost metric(s) may be used as a basis for determining the shortest and lowest cost paths of the tree representation of the distributed environment (e.g., bandwidth consumption, monetary cost, or the like, as well as various combinations thereof). The tree representation of the distributed environment may be a minimal Steiner tree or any other suitable type of minimal tree configured to optimize one or more cost metrics.

In at least some embodiments, the tree representation of the distributed environment may have already been created, such that determining tree representation of the distributed environment may simply include retrieval of tree representation of the distributed environment from storage.

At step 730, a distributed query plan is determined for the streaming query plan based on the centralized query plan for the streaming query and based on the tree representation of the distributed environment. The distributed query plan is configured for a distributed deployment of the streaming query within the distributed environment. The distributed query plan may be determined by determining, for each query primitive of the centralized query plan, a mapping of the query primitive onto one or more of the vertices of the tree representing the distributed environment. Accordingly, the distributed query plan may be represented as a set of mappings of the query primitives of the centralized query plan onto sets of vertices of the tree representing the distributed environment, respectively.

At step 740, a distributed query deployment plan is determined for the streaming query based on the distributed query plan for the streaming query. The distributed query deployment plan is configured to enable deployment and activation of the streaming query within the distributed environment. The distributed query deployment plan may be determined by determining, for each query primitive of the centralized query plan, a mapping of the query primitive onto one or more elements of the distributed environment, where the elements may be at any suitable granularity (e.g., processing nodes, portions of processing nodes, or the like, as well as various combinations thereof). The determination of a mapping of a given query primitive of the centralized query plan onto one or more elements of the distributed environment may be determined based on a mapping of the vertex of the tree representing the distributed environment to the underlying element of the distributed environment that is represented by that vertex of the tree representing the distributed environment (e.g., a mapping of the vertex to the processing node represented by that vertex in the tree representing the distributed environment). Accordingly, the distributed query deployment plan may be represented as a set of mappings of the query primitives of the centralized query plan onto elements of the distributed environment, respectively. At step 750, the streaming query plan is deployed and activated within the distributed environment.

At step 799, method 700 ends.

It will be appreciated that, in at least some embodiments, steps of method 700 of FIG. 7 may be implemented as depicted and described for corresponding steps of FIG. 3 or FIG. 4.

It will be appreciated that, although primarily depicted and described with respect to embodiments in which the minimal tree representing the distributed environment in which the streaming query is to be deployed is configured to reduce or minimize bandwidth consumption, in at least some embodiments the minimal tree representing the distributed environment in which the streaming query is to be deployed may be configured to reduce or minimize one or more other types of resources which may be consumed as a result of deployment of the streaming query within the distributed environment (e.g., processing resources of the processing nodes of the distributed environment, memory resources of the processing nodes of the distributed environment, or the like, as well as various combinations thereof).

The SQCS 120 may be configured to improve or optimize the performance of a streaming query within an environment based on measurement data collected from the environment.

In at least some embodiments, SQCS 120 may be configured to improve or optimize the performance of a streaming query within an environment based on measurement data collected from the environment by monitoring one or more parameters related to execution of the streaming query within the environment and dynamically improving or optimizing the steaming query based on the current or expected future state of the environment.

In at least some embodiments, SQCS 120 may be configured to improve or optimize the performance of a streaming query within an environment based on measurement data collected from the environment by determining a streaming query, deploying and activating the streaming query within the environment, collecting measurement data related to execution of the streaming query within the environment, generating a modified streaming query (providing an improvement over or optimization of the streaming query) based on measurement data collected from the environment, and deploying and activating the modified streaming query within the environment (which also may be accompanied by deactivation and removal of the original streaming query from the environment).

It is noted that various embodiments of the implementation of SQCS 120 primarily depicted and described within the context of improving or optimizing the deployment of a streaming query to an environment (e.g., depicted and described with respect to FIGS. 2-7) also may be used to provide various embodiments of the capability for improving or optimizing performance of a streaming query within an environment based on measurement data collected from the environment.

The SQCS 120 may be configured to determine a streaming query, deploy the streaming query to the communication network 110, and activate the streaming query within the communication network 110. The streaming query may be determined by retrieving the streaming query where the streaming query has already been generated, by generating the streaming query (e.g., by transforming a query expression (e.g., specified in a query language, such as a language similar to SQL or using any other suitable type of query language) into a sequence of processing steps configured to execute the streaming query), or the like. In general, a streaming query is specified as a streaming query plan and a streaming query deployment plan. The streaming query may be determined and deployed using a query plan compiler and a query execution engine, as discussed in additional detail below. The streaming query that is determined, deployed, and activated represents an original streaming query that is to be modified by SQCS 120, based on measurement data collected from the environment, to form the modified streaming query that provides an improvement over or optimization of the original streaming query. The operation of SQCS 120 in determining a streaming query, deploying the streaming query to the communication network 110, and activating the streaming query within the communication network 110 has been described hereinabove and, thus, is not repeated here.

The SQCS 120 may be configured to collect, from communication network 110, measurement data related to the streaming query. The SQCS 120 may collect measurement data by configuring processing nodes 112 to provide measurement data to SQCS 120, querying processing nodes 112 to retrieve measurement data (e.g., periodically, responsive to detection of a condition or event, or the like), or the like, as well as various combinations thereof.

In at least some embodiments, SQCS 120 may be configured to control collection of the measurement data which may be evaluated for determining whether to modify the streaming query to improve the performance of the streaming query and, where a determination is made to modify the streaming query, the manner in which the streaming query is modified.

In at least some embodiments, SQCS 120 may be configured to control collection of the measurement data including values of a set of parameters, which may include one or more parameters. The set of parameters may include one or more of event stream rates (e.g., event stream rates per event source instance), group-by key distribution for grouping components, pass-through rates for filter components, event processing throughput (e.g., per component), processing latency (e.g., per component, per processing node, end-to-end, or the like), bandwidth consumption between processing nodes, link latencies, or the like, as well as various combinations thereof). The set of parameters may be specific to the streaming query, associated with multiple (or even all) streaming queries controlled by SQCS 120, or the like.

In at least some embodiments, SQCS 120 may be configured to control collection of the measurement data using a set of monitoring and feedback control loops between SQCS 120 and the processing nodes 112, which may be configured in a number of ways. The control loops may be provided using wrappers applied to portions of the streaming query plan, placement of taps on processing nodes, placement of taps on links between processing nodes, placement of taps supporting end-to-end measurement data collection, or the like, as well as various combinations thereof.

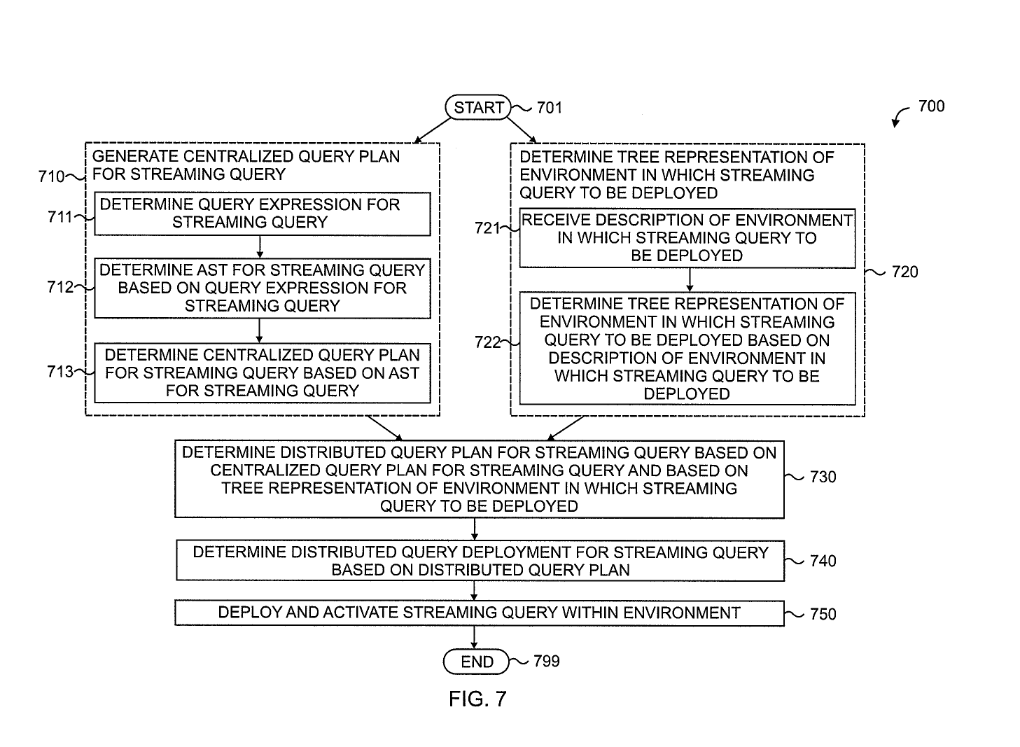

In at least some embodiments, SQCS 120 may be configured to control collection of measurement data for a streaming query based on use of a wrapper(s) for a portion(s) of the streaming query plan. In general, a wrapper for a portion of a streaming query plan may include one or more data measurement taps (referred to more generally herein as taps). For example, a wrapper for a portion of a streaming query plan may include an input tap only, an output tap only, or both an input tap and an output tap. The tap(s) of a wrapper for a query primitive of a streaming query plan may be configured to collect measurement data and provide the measurement data to SQCS 120 (e.g., automatically, responsive to requests from SQCS 120, or the like, as well as various combinations thereof). The implementation of a wrapper for a portion of a streaming query plan may depend on the portion of streaming query plan for which the wrapper is being provided (e.g., source component versus primitive, for different primitive types, primitive versus sink component, or the like). For example, a wrapper around a SOURCE component of a streaming query plan may only include an output tap (e.g., for measuring current event rate, average event rate over a given sample period, or the like, as well as various combinations thereof). For example, a wrapper around a FILTER primitive of a streaming query plan may include an input tap (e.g., for measuring the amount of events entering the FILTER) and an output tap (e.g., for measuring the amount of events passing the FILTER), thereby enabling calculation of the pass ratio (@PASS_RATIO) of the filter by dividing the output measurement from the output tap by the input measurement from the input tap. For example, a wrapper around a GROUP-BY primitive may measure the input key distribution (e.g., the fraction of events that have a certain value for the GROUP-BY key), the selectivity factor (which is basically the inverse of the amount of distinct groups that are to be expected per time window), or the like, as well as various combinations thereof. An exemplary wrapper architecture for a wrapper for a query primitive of a streaming query plan of a streaming query is depicted in FIG. 8. As depicted in FIG. 8, wrapper 800 wraps a query primitive (illustratively, query primitive implementation 801) with an input tap 810₁ and an output tap 810₀. As discussed above, a wrapper may only include an input tap or an output tap, depending on the type of query primitive to which the wrapper is applied.

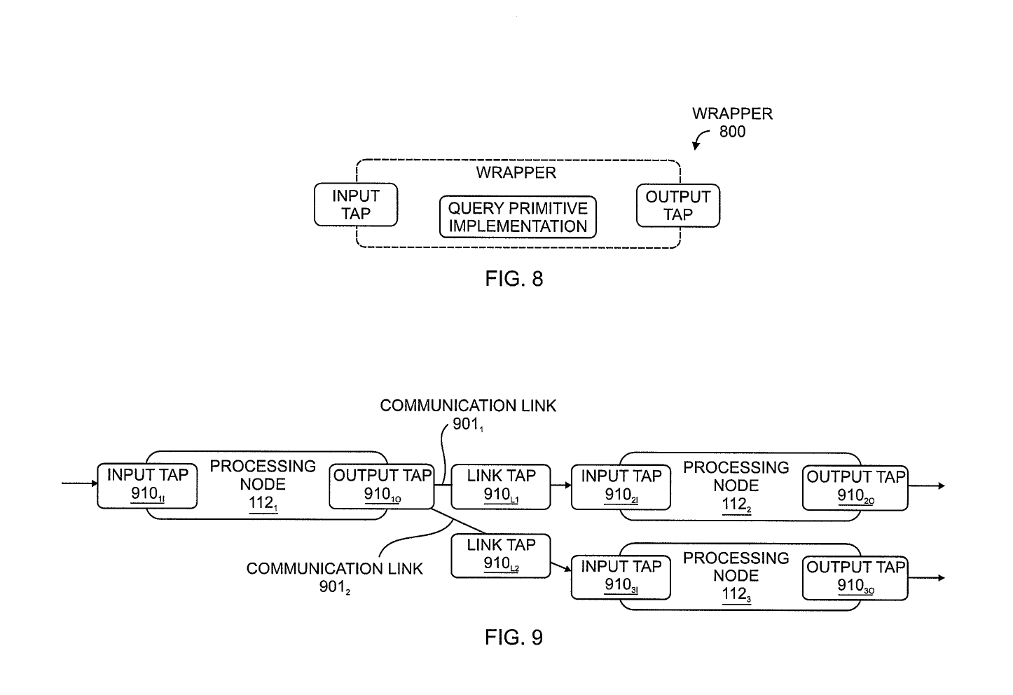

In at least some embodiments, SQCS 120 may be configured to control collection of measurement data for a streaming query based on use of data measurement taps (again, referred to herein as taps). The taps may be placed on processing nodes, on links connecting processing nodes, or the like, as well as various combinations thereof. The taps placed on processing nodes may be configured to measure throughput, latency (e.g., between the input tap and output tap of a given processing node, between the output tap of a first processing node and the input tap of a second processing node, or the like), or the like, as well as various combinations thereof. The taps placed on links between processing nodes may be configured to measure bandwidth usage, latency, throughput (e.g., in terms of number of events that pass the link) or the like, as well as various combinations thereof. In general, a given tap or set of taps may be configured to collect measurement data and provide the measurement data to the SQCS 120 (e.g., automatically, responsive to requests from SQCS 120, or the like, as well as various combinations thereof). The measurement data collected based on taps may be processed by SQCS 120 for improving a streaming query plan of a streaming query (e.g., parallelism of execution of primitives determined based on measurement data from taps on processing nodes), a streaming query deployment of a streaming query (e.g., mapping of primitives to processing nodes determined based on measurement data from taps on processing nodes or links between processing nodes, parallelism of deployment of primitives on processing nodes determined based on taps on processing nodes, or the like), or the like, as well as various combinations thereof. An exemplary deployment of taps on processing nodes and links between processing nodes is depicted in FIG. 9. As depicted in FIG. 9, a first processing node 112₁ is communicatively connected to a second processing node 112₂ via a first communication link 901₁ and is communicatively connected to a third processing node 112₃ via a second communication link 901₂. The first processing node 112₁ includes an input tap 910_{1I} and an output tap 910_{1O}. The second processing node 112₂ includes an input tap 910_{2I} and an output tap 910_{2O}. The third processing node 112₃ includes an input tap 910_{3I} and an output tap 910_{3O}. The first communication link 901₁ includes a link tap 910_{L1} and the second communication link 901₂ includes a link tap 910_{L2}. As discussed above, the taps 910 may be used individually or in various combinations for collecting various types of measurement data for SQCS 120.

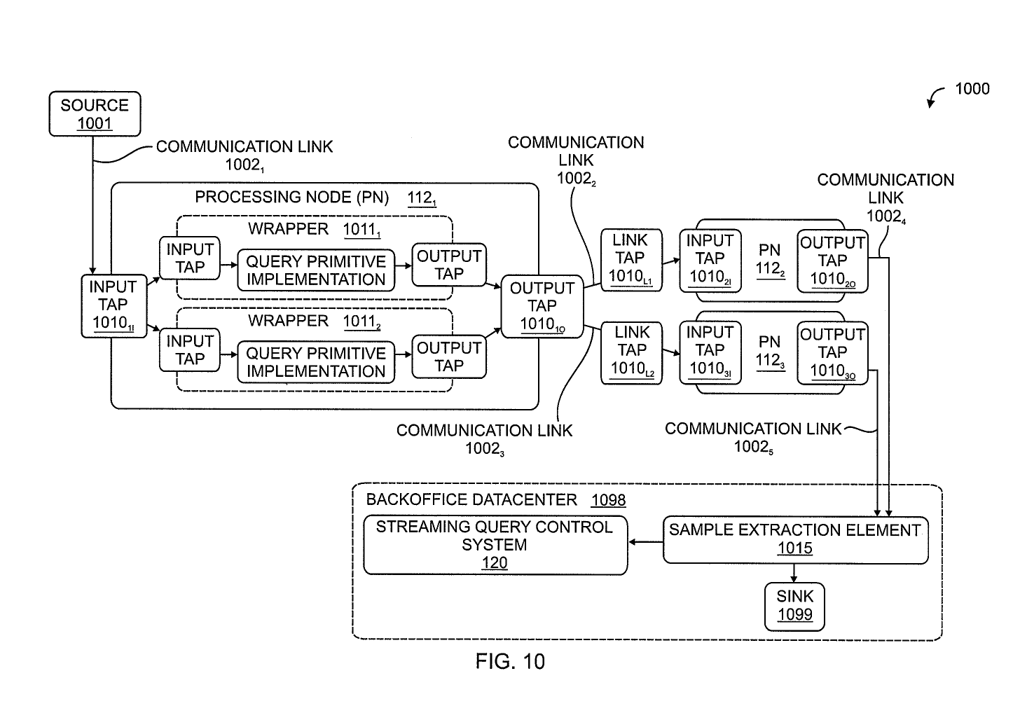

In at least some embodiments, SQCS 120 may be configured to control collection of measurement data for a streaming query based on use of a combination of wrappers and data measurement taps (again, referred to herein as taps). An exemplary deployment of a combination of wrappers and taps for end-to-end collection of measurement data is depicted in FIG. 10. As depicted in FIG. 10, a streaming query is configured to query event streams flowing from a SOURCE 1001 to a SINK 1099 via a set of processing nodes 112₁-112₃ (collectively, processing nodes 112). The SINK 1099 is depicted as being located within a backoffice datacenter 1098. The SOURCE 1001 is communicatively connected to a first processing node 112₁ via a first communication link 1002₁, the first processing node 112₁ is communicatively connected to a second processing node 112₂ via a second communication link 1002₂ and is communicatively connected to a third processing node 112₃ via a third communication link 1002₃, the second processing node 112₂ is communicatively connected to the backoffice datacenter 1098 via a fourth communication link 1002₄, and the third processing node 112₃ is communicatively connected to the backoffice datacenter 1098 via a fifth communication link 1002₅. The first processing node 112₁ includes an input tap 1010_{1I} and an output tap 1010_{1O}. The second processing node 112₂ includes an input tap 1010_{2I} and an output tap 1010_{2O}. The third processing node 112₃ includes an input tap 1010_{3I} and an output tap 1010_{3O}. The second communication link 1002₂ includes a link tap 1010_{L1} and the third communication link 1002₃ includes a link tap 1010_{L2}. The first processing node 112₁ also includes a first wrapper 1011₁ and a second wrapper 1011₂ (collectively, wrappers 1011) deployed on first processing node 112₁ in parallel (illustratively, the output of input tap 1010_{1I} is connected to input taps of respective wrappers 1011 and output taps of respective wrappers 1011 are connected to the input to output tap 1010_{1O}). The wrappers 1011 are similar to wrapper 800 depicted and described with respect to FIG. 8. The backoffice datacenter 1098 also includes a sample extraction element 1015 which is (1) coupled to the output of the output tap 1010_{O2} of second processing node 112₂ via the fourth communication link 1002₄ and (2) coupled to the output of the output tap 1010₀₃ of second processing node 112₃ via the fifth communication link 1002₅. As depicted in FIG. 10, sample extraction element 1015 may be configured to (1) extract measurement data (e.g., produced and concatenated by the various taps in the path from SOURCE 1001 to SINK 1099, and piggybacked on top of the event data propagating from SOURCE 1001 to SINK 1099) and to provide the extracted measurement data to SQCS 120 (which, for purposes of clarity, also is depicted as being included within backoffice datacenter 1098) and (2) to relay the events received at sample extraction element 1015 to the output port of sample extraction element 1015 that is connected to the SINK (after having removed the piggybacked measurement data). As discussed above, the taps 1010 and wrappers 1011 may be used individually or in various combinations for collecting various types of measurement data for SQCS 120.

The communication of measurement data to SQCS 120 may be provided in various ways. For example, measurement data may be provided to SQCS 120 using out-of-band communication, in-band communication (e.g., via annotating of at least a portion of the existing events using metadata to represent the measurement data and then extracting the measurement data from the existing events before the existing events are provided to the SINK component of the streaming query, as depicted in FIG. 10), or the like, as well as various combinations thereof. Thus, it will be appreciated that wrappers and taps may be configured to provide such functions for reporting of measurement data to the SQCS 120 and, similarly, that the SQCS 120 may be configured to support functions for receiving measurement data in various ways.

The SQCS 120 may be configured to monitor and evaluate the collected measurement data to determine whether to modify the streaming query. The monitoring and evaluation of the collected measurement data may be performed for measurement data associated with a set of parameters (e.g., for a determination that a value or values of a particular parameter satisfy a threshold associated with the parameter, for a determination that values for a specific combination of parameters satisfy associated thresholds for the parameters, detection of changes to values of one or more parameters, or the like, as well as various combinations thereof). The monitoring and evaluation of the collected measurement data may be periodic, continuous, or the like. The monitoring and evaluation of the collected measurement data may depend on the type of streaming query for which evaluation is being performed, the type of improvement or optimization expected to be performed for the streaming query (e.g., improvement or optimization of the streaming query plan, improvement or optimization of the streaming query deployment (e.g., in terms of parallelization of primitives, network paths used, or the like), or the like, as well as various combinations thereof). The monitoring and evaluation of the collected measurement data may be reactive (e.g., performed in response to a detected condition or event) or proactive (e.g., for detecting potential streaming query improvements or optimizations in advance of the need for such streaming query improvements or optimizations). The various types of monitoring and evaluation which may be performed for collected measurement data may be better understood by way of various examples provided above in conjunction with descriptions of the collection of measurement data.

In at least some embodiments, SQCS 120 may be configured to control collection of the measurement data related to evaluation of the streaming query plan of the streaming query (e.g., the set of query primitives used, the order of the query primitives, or the like). For example, where the goal is to improve the performance of the streaming query by reducing the event stream, SQCS 120 may identify a subset of the query primitives of the streaming query for which the order of the query primitives of the streaming query plan may be modified without breaking the semantic equivalence of the streaming query plan, modify the streaming query plan for the streaming query in a manner for enabling collection of measurement data related to evaluation of the impact of re-ordering of the subset of primitives of the streaming query plan on reducing the event stream, and deploy the modified streaming query for enabling collection of measurement data related to evaluation of the impact of re-ordering of the subset of primitives of the streaming query plan on reducing the event stream. This example may be better understood by considering a more specific implementation that is based on the exemplary streaming query for calculating the top 10 HTTP hosts based on download footprint, which was discussed above and depicted with respect to FIGS. 2A and 2B. In this example, it is assumed that there is a recognition that there may be an opportunity to improve the performance of the streaming query for calculating the top 10 HTTP hosts based on download footprint by changing the order of primitives of the streaming query plan of the streaming query; however, SQCS 120 does not have enough information to determine whether changing the order of primitives of the streaming query plan of the streaming query will in fact improve the performance of the streaming query for calculating the top 10 HTTP hosts based on download footprint. It will be understood that the order of the query primitives of the streaming query may be modified to the extent that the modification does not break the equivalence of the streaming query. In this example, given a goal of reducing the event stream, the most optimal ordering of the query primitives of the streaming query is such that the query primitives that reduce the event stream the most are called first. For the streaming query for calculating the top 10 HTTP hosts based on download footprint, only the PROJECT and FILTER primitives can swap places without breaking semantic equivalence of the streaming query. The PROJECT primitive reduces the event size by eliminating event attributes that are not needed in the streaming query. The FILTER primitive allows events to pass through if the events match certain conditions defined by the FILTER primitive. However, as noted above, SQCS 120 does not know whether the PROJECT primitive or the FILTER primitive reduces the event streams the most (e.g., in bytes/s), because it is unknown how many events will be filtered out of the event stream by the FILTER primitive. Rather, the only thing that the SQCS 120 can calculate from the given streaming query is how much the PROJECT primitive reduces the event stream. For example, the SQCS 120 may calculate how much the PROJECT primitive reduces the event stream by analyzing the schema of the event type (EventSource) and the minimal set of fields necessary for calculating the result of the given streaming query. Accordingly, in order to enable SQCS 120 to optimize this streaming query, the measurement data produced by the FILTER primitive tap may be used to modify the streaming query plan to include a parameter (denoted as @PASS_RATIO) indicating the fraction of events that are expected to pass the FILTER. Here, the @PASS_RATIO parameter essentially functions as a hint indicating the fraction of events that are expected to pass the FILTER. The streaming query is modified to include the @PASS_RATIO parameter by modifying the WHERE clause of the streaming query plan to: {WHERE http_host !=“unknown” @PASS_RATIO=0.3}. The SQCS 120, based on the provided @PASS_RATIO hint, is able to calculate whether the FILTER primitive or the PROJECT primitive reduces the event stream the most. If the SQCS 120 determines, based on the hint deduced from the measurement data, that the PROJECT primitive reduces the event stream the most, the SQCS 120 does not modify the streaming query (i.e., the streaming query plan maintains the ordering of primitives depicted in FIG. 2). If the SQCS 120 determines, based on the hint deduced from the measurement data, that the FILTER primitive reduces the event stream the most, the SQCS 120 modifies the streaming query (i.e., the streaming query plan depicted in FIG. 2 is modified to have an ordering of primitives of SOURCE→FILTER→PROJECT→AGGREGATE→ORDER-BY→LIMIT→SINK) and deploys the modified streaming query to the communication network 110.

In at least some embodiments, SQCS 120 may be configured to control collection of the measurement data related to evaluation of the streaming query deployment plan of the streaming query (e.g., the set of processing nodes used, the mapping of query primitives to the processing nodes, the mapping of query primitives to components of the processing nodes, or the like). For example, where the goal is to improve the performance of the streaming query via improved deployment of the streaming query, SQCS 120 may control collection of measurement data related to evaluation of the impact of a modified deployment of the streaming query. Such embodiments may be better understood by considering two more specific examples, discussions of which follow.

In a first example related to obtaining measurement data for evaluation of the streaming query deployment of a streaming query, consider the exemplary streaming query for calculating the top 10 HTTP hosts based on download footprint, which was discussed above and depicted with respect to FIGS. 2A and 2B. In this example, the streaming query may be modified in a manner enabling a determination as to whether or not the data stream is naturally partitioned on the GROUP-BY key (here, http_host). The data streams of a system are considered to be naturally partitioned on the http_host GROUP-BY key if each event stream produces events for a mutually exclusive set of HTTP hosts. Accordingly, in order to enable SQCS 120 to optimize this streaming query, the streaming query may be modified by modifying the streaming query plan to include a parameter (denoted as @PARTITIONED_ON) indicating the basis for partitioning of the GROUP-BY key. Here, the @PARTITIONED_ON parameter essentially functions as a hint indicating the basis for partitioning of the GROUP-BY key. The streaming query is modified to include the @PARTITIONED_ON parameter by modifying the FROM clause of the streaming query plan to: {FROM EventSource.win:time(15 min) @PARTITIONED_ON=“http_host”}. The SQCS 120, based on the provided hint, is able to determine whether the streaming query may be executed fully in parallel per stream (assuming that the parallel results are later put together in one set, ordered again, and limited to the 10 highest values, in order to produce the final result providing the top 10 HTTP hosts based on download footprint).

In a second example related to obtaining measurement data for evaluation of the streaming query deployment of a streaming query, consider an exemplary streaming query for calculating the top 10 users that download the most data (as opposed to the top 10 HTTP hosts based on download footprint). It is noted that, while knowledge as to whether or not the event streams are naturally partitioned may be determined statically in some cases (e.g., such as in the case of the exemplary streaming query for calculating the top 10 HTTP hosts based on download footprint), there may be other cases in which the event streams are “mostly partitioned” on a certain GROUP-BY key (e.g., such as in the case of exemplary streaming query for calculating the top 10 users that download the most data). An exemplary streaming query expression for determining the top 10 users that download most data may be expressed as follows.
SELECT user_id, SU M(download_bytes)
as download_volume
FROM EventSource.win:time(15 min)
WHERE user_id !=“unknown”
GROUP-BY user_id
ORDER-BY download_volume DESC
LIMIT 10
   Here, the event streams are “mostly partitioned” due to the fact that at least some of the users may be roaming between wireless network access points. More specifically, assuming that most download traffic is coming from the fixed network, this means that the event streams (which tap information in specific locations) will naturally be mostly partitioned on the user_id key; and it is expected that only when the user is roaming would the user_id of the user arrive at the “wrong” event source (i.e., in a different event stream). While the fraction of roaming users is something that can be estimated (and, thus, hinted), actual measurements of nomadic behavior of users are expected to be more accurate and, thus, could lead to much better optimizations of the streaming query deployment and, thus, the streaming query. Accordingly, in order to enable SQCS 120 to optimize this streaming query, the streaming query may be modified by modifying the streaming query expression to include an additional statement (denoted as PARTITION ON user_id) indicating that the event streams are to be partitioned explicitly (by means of the implementation of the PARTITION ON primitive, which is to be installed on the first processing node encountered in the path starting at a SOURCE and ending in the SINK, for each SOURCE) on the GROUP-BY key. Thus, the above streaming query expression may rewritten as follows.
SELECT user_id, SU M(download_bytes) AS download_volume
FROM EventSource.win:time(15 min)
WHERE user_id !=“unknown”
PARTITION ON user_id
GROUP-BY user_id
ORDER-BY download_volume DESC
LIMIT 10
   Here, the PARTITION ON statement essentially functions as an instruction to make sure to relay any events arriving at the wrong event source to the correct event source. It also indicates to SQCS 120 that the basis for partitioning is the GROUP-BY key. The streaming query is modified to include the PARTITION ON statement by adding the PARTITION ON statement to the streaming query expression, thereby ensuring that the event stream is partitioned on the GROUP-BY key before arriving at the various processing nodes. The SQCS 120, based on the measurements (e.g., measurements indicative of nomadic behavior of users), is able to determine whether the streaming query may benefit from explicit partitioning. If so, the SQCS 120 adds the PARTITION ON statement as indicated above, to optimize the streaming query plan. As a result, the streaming query can be executed fully in parallel per stream (assuming that the parallel results are later put together in one set, ordered again, and limited to the 10 highest values, in order to produce the final result providing the top 10 HTTP hosts based on download footprint).

In at least some embodiments, hints specified in query language of streaming queries may be modified dynamically as measurement data is collected based on streaming queries using the hints. For example, an initial hint value may be specified in the streaming query language of a streaming query, the streaming query may be deployed, measurement data may be collected by the taps of the query primitives, the per-node taps and/or the link taps, the initial hint value may be modified based on collected measurement data, and so forth, thereby enabling dynamic improvements to hint values used for optimization of the streaming query. This may obviate the need for data analysts to estimate realistic hints in order to realize improvements in streaming query performance.

It will be appreciated that, although primarily depicted and described with respect to use of specific types of hints in query language of streaming queries, various other types of hints may be used for optimizing streaming queries.

It will be appreciated that, although primarily described with respect to embodiments in which measurement data is collected and evaluated in a manner for attempting to improve a single characteristic of the streaming query (e.g., the order of primitives of the streaming query plan, the deployment of the streaming query plan, or the like), in at least some embodiments measurement data may be collected and evaluated in a manner for attempting to improve multiple characteristics of the streaming query.

The SQCS 120 may be configured to modify the streaming query to form a modified streaming query.

The modification of the streaming query may be based on the type of modifications which are permitted for the streaming query without breaking the semantic equivalence of the streaming query (e.g., a subset of primitives of the streaming query plan for which re-ordering is permitted, a subset of the query primitives of the streaming query plan for which modifications in parallelization are permitted, deployment modifications which may be made to the streaming query deployment of the streaming query, modifications that may require additional primitives to be inserted in the modified query plan (as determined by substitution rules) to make sure the modified query plan is semantically equivalent with the original query plan, or the like, as well as various combinations thereof). The modification of the streaming query may be based on the type of performance metric(s) to be improved for the streaming query.

The modification of a streaming query may include modifying the streaming query plan of the streaming query (e.g., modifying the set of query primitives used, modifying the definition of one or more of the query primitives modifying the sequence of query primitives, or the like, as well as various combinations thereof). As discussed above, for example, modification of the streaming query plan may be based on values of one or more parameters of the measurement data obtained by SQCS 120 (e.g., event stream rates, key distribution, pass-through rates, or the like, as well as various combinations thereof).

The modification of a streaming query may include modifying the streaming query deployment of the streaming query. The modification of the streaming query deployment of the streaming query may include modifying the degree of parallelism of deployment of the streaming query (e.g., degree of parallelism per processing node, degree of parallelism across processing nodes, or the like, as well as various combinations thereof), modifying the deployment tree of the streaming query (e.g., the mapping of query primitives of the streaming query plan to the set of processing nodes for the streaming query, the set of processing nodes that are assigned to execute portions of the streaming query plan (e.g., based on processing capabilities or capacity of processing nodes, based on bandwidth of communication paths between processing nodes, or the like, as well as various combinations thereof), or the like, as well as various combinations thereof. As discussed above, for example, the modification of the streaming query deployment of the streaming query may be based on values of one or more parameters of measurement data obtained by SQCS 120, measured processing capacities of processing nodes, measured capacities of communication links (e.g., selected in order to avoid clogging paths in the network topology, such as when multiple streaming queries are running in parallel on the same network or in response to any other conditions which may cause clogging of paths in the network topology), or the like, as well as various combinations thereof.

The SQCS 120 may be configured to deploy the modified streaming query within communication network 110. The modified streaming query is deployed within the communication network 110 based on the streaming query deployment specified for the modified streaming query. The modified streaming query may be deployed within communication network 110 by sending configuration messages to certain processing nodes 112 for triggering configuration of the processing nodes 112 (and, where relevant, components of the processing nodes 112) to execute the query primitives of the streaming query plan based on the mapping of the query primitives of the streaming query plan to the processing nodes 112, respectively. It will be appreciated that the modified streaming query may be deployed within communication network 110 in any other suitable manner.

In at least some embodiments, SQCS 120 may deploy the modified streaming query within communication network 110 while also maintaining the streaming query (i.e., the existing streaming query upon which the modified streaming query is based) within communication network 110. This enables the existing streaming query to continue to operate within communication network 110 while the modified streaming query is activated within communication network 110 and, in at least some cases, brought to a state in which the modified streaming query is producing relevant query results. It will be appreciated that the modified streaming query may need at least some time to operate within communication network 110 before producing relevant query results as various types of streaming queries need at least some limited historical information in order to produce relevant query results (e.g., in order to perform the relevant grouping). In at least some embodiments, one or more windowing techniques (e.g., time windows, fixed length windows, sliding or tumbling variants of such windows, or the like) may be used in order to enable the modified streaming query to collect at least some limited historical information in order to produce relevant query results. An example was previously provided within the context of the top-N query (e.g., the statement FROM EventSource.win:time(15 min) specifies a sliding time window of 15 minutes). In at least some embodiments, state buildup in these time windows may be handled using various state migration or synchronization techniques (e.g., copying information from the event streams, processing a duplicated copy of the event streams in parallel to the existing streaming query for the duration of the longest time window, or the like). Following use of such techniques to bring the modified streaming query to a state in which the modified streaming query is producing relevant query results, the existing streaming query may be deactivated and removed from communication network 110.

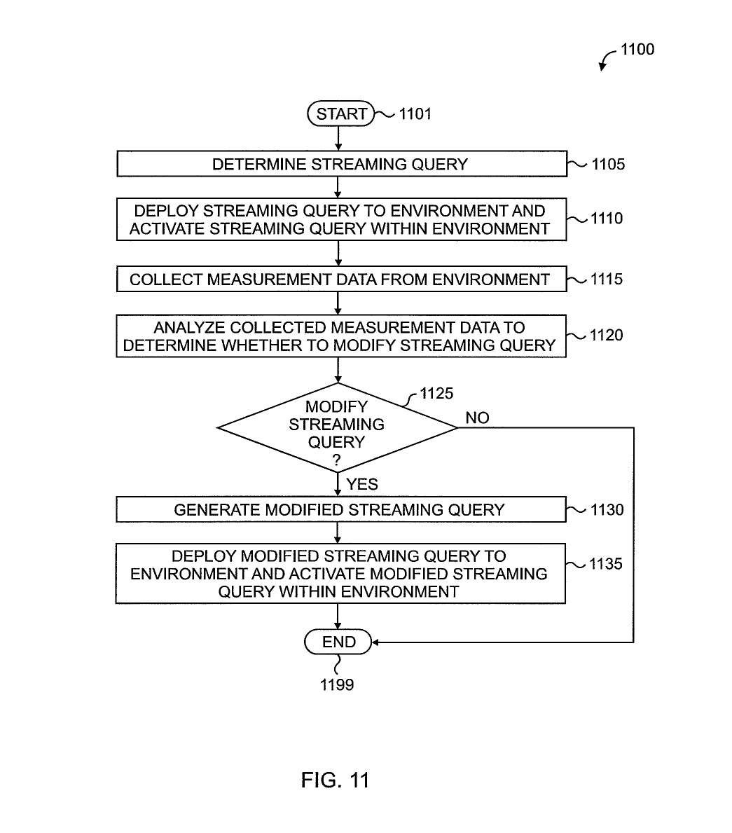

FIG. 11 depicts an embodiment of a method for generating a modified streaming query from a streaming query based on measurement data collected for the streaming query. It will be appreciated that, although depicted and described as being performed serially, at least a portion of the steps of method 1100 may be performed contemporaneously or in a different order than presented in FIG. 11. At step 1101, method 1100 begins. At step 1105, a streaming query is determined (e.g., generated, selected from a library of existing streaming queries, or the like). At step 1110, the streaming query is deployed to the environment and activated within the environment. At step 1115, measurement data is collected from the environment. The measurement data may be collected from the environment based on one or more of modification of the streaming query in a manner enabling collection of measurement data, use of existing or deployment of new query primitive wrappers for the streaming query, use of existing or deployment of new data measurement taps within the environment (e.g., on one or more processing nodes, within one or more processing nodes, on one or more communication paths, or the like), or the like, as well as various combinations thereof. At step 1120, the collected measurement data is analyzed to determine whether to modify the streaming query. At step 1125, a determination is made as to whether the streaming query is to be modified. If a determination is made that the streaming query is not to be modified, method 1100 proceeds to step 1199, where method 1100 ends. If a determination is made that the streaming query is to be modified, method 1100 proceeds to step 1130. At step 1130, a modified streaming query, which is a modified version of the streaming query, is generated. At step 1135, the modified streaming query is deployed to the environment and activated within the environment. From step 1135, method 1100 proceeds to step 1199, where method 1100 ends. It will be appreciated that, although depicted and described as ending (for purposes of clarity), method 1100 or portions of method 1100 may continue to be executed for the streaming query continuously monitor measurement data associated with the streaming query in order to improve or optimize the streaming query based on the current or expected future state of the environment in which the streaming query is deployed.

As described herein, embodiments of the capability for improving streaming query performance may provide various advantages for execution of streaming queries. For example, various embodiments of the capability for improving streaming query performance may support elasticity in a streaming query analytics system, such as by enabling increases in allocated streaming query resources when event loads increase and increased streaming query analytics processing is necessary or desirable, and enabling decreases in allocated streaming query resources when event loads decrease and decreased streaming query analytics processing is necessary or desirable (e.g., for conserving resources, energy, or the like). For example, various embodiments of the capability for improving streaming query performance may improve the performance of streaming queries with little or no downtime and with little or no visible impact on the performance of data stream processing. For example, various embodiments of the capability for improving streaming query performance may significantly reduce the time or the processing power needed to execute streaming analytics queries. For example, various embodiments of the capability for improving streaming query performance may be used to add partially or fully automated elasticity to streaming analytics applications, such as by dynamically adjusting the amount of resources (e.g., hardware, bandwidth, execution parallelism, or the like) required to process streaming analytics data (e.g., adjusting the amount of resources to that which is minimally necessary based on current conditions, adjusting the amount of resources based on detected conditions or events, adjusting the amount of resources based on predictions of conditions or events, or the like). For example, various embodiments of the capability for improving streaming query performance have been analyzed and found to produce improvements of at least two orders of magnitude between an existing streaming query and an improved streaming query for at least some streaming query types (with the realized level of improvement expected to vary across at least some streaming query types). Various other advantages are contemplated.

The SQCS 120 may be configured to improve or optimize deployment of multiple streaming queries to an environment. In at least some embodiments, SQCS 120 may be configured to improve or optimize deployment of multiple streaming queries to an environment by determining a common characteristic of the multiple streaming queries and generating, based on the common characteristic, a query plan configured to provide integrated deployment of the multiple streaming queries within an environment. The common characteristic of the multiple streaming queries may be associated with usage of resources (e.g., processing resources, memory resources, storage resources, bandwidth resources, or the like, as well as various combinations thereof) used for deployment or execution of the multiple streaming queries within the environment. For example, generation of a query plan configured to provide integrated deployment of the multiple streaming queries within the environment may enable reductions in the processing resources used to support the multiple streaming queries within the environment, reductions in the memory resources used to support the multiple streaming queries within the environment, reductions in the storage resources used to support the multiple streaming queries within the environment, reductions in the bandwidth resources used to support the multiple streaming queries within the environment, or the like, as well as various combinations thereof. For purposes of clarity, since it will be understood that aggregation windows of streaming queries are a typical source of memory consumption in streaming queries, various embodiments of the capability for improving or optimizing deployment of multiple streaming queries to an environment are primarily depicted and described herein with respect to embodiments in which the common characteristic of the multiple streaming queries is a common aggregation window of the multiple streaming queries (although it will be appreciated that other types of characteristics may be exploited to provide various other types of improvements and optimizations).

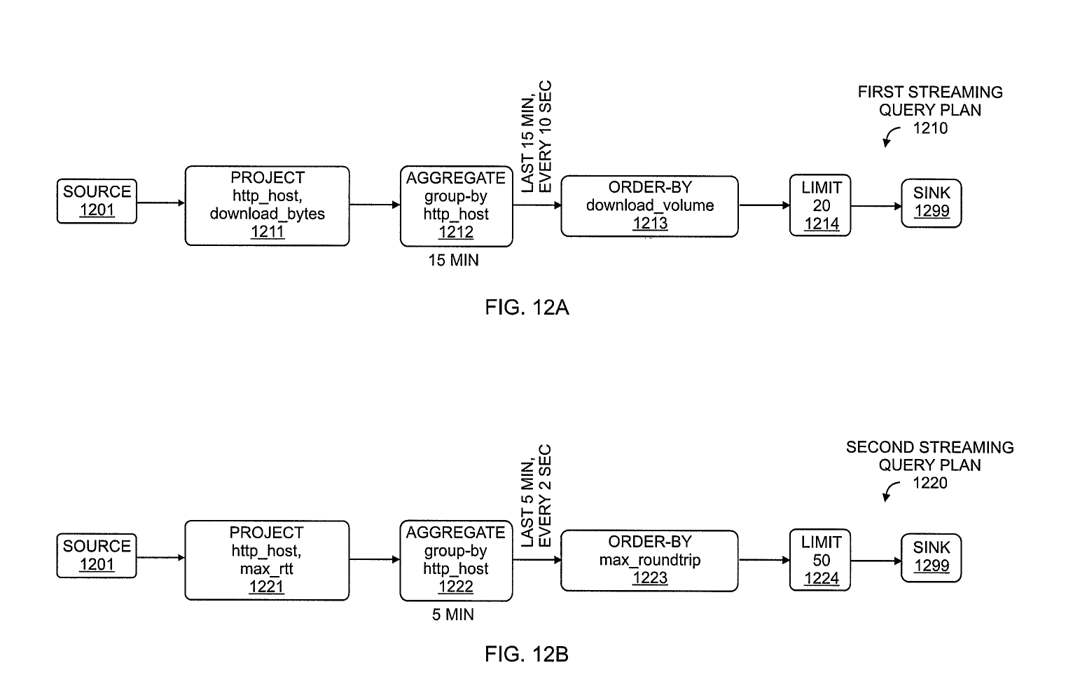

In at least some embodiments, SQCS 120 may be configured to improve or optimize deployment of multiple streaming queries to an environment by determining a common aggregation window of the multiple streaming queries and generating, based on the common aggregation window, a streaming query plan for the multiple streaming queries that is configured to support sharing of the common aggregation window by the multiple streaming queries within the environment. As discussed in additional detail below, this may be used for improving or optimizing deployment of multiple streaming queries where (1) none of the multiple streaming queries have been activated within the environment or (2) one or more of the streaming queries have been activated within the environment and one or more of the streaming queries have not yet been activated within the environment. It is noted that various embodiments of the implementation of SQCS 120 primarily depicted and described within the context of improving or optimizing the deployment of a streaming query to an environment (e.g., depicted and described with respect to FIGS. 2-7) or the improving or optimizing the performance of a streaming query plan within an environment (e.g., depicted and described with respect to FIGS. 8-11) also may be used in conjunction with various embodiments of the capability for improving or optimizing deployment of multiple streaming queries to an environment. The operation of SQCS 120 in improving or optimizing deployment of multiple streaming queries to an environment may be better understood by considering two exemplary streaming queries, as depicted in FIGS. 12A and 12B.

FIGS. 12A-12B depict two exemplary streaming queries for which an integrated streaming query may be deployed and activated within an environment.

FIG. 12A depicts a first streaming query plan for a first streaming query. The first streaming query is a continuous query calculating, every 10 seconds, the top-20 HTTP hosts generating the highest download volumes, based on measurements collected during the last 15 minutes. This first streaming query plan may be generated from the following streaming query expression.
SELECT http_host, SUM(download_bytes) AS download_volume
FROM EventSource.win:time(15 min)
GROUP-BY http_host
OUTPUT EVERY 10 seconds
ORDER-BY download_volume DESC
LIMIT 20
   As noted above, the first streaming query plan 1210 for the first streaming query is depicted in FIG. 12A. As depicted in FIG. 12A, the first streaming query plan 1210 includes a SOURCE node 1201, a PROJECT primitive 1212, an AGGREGATE primitive 1213, an ORDER-BY primitive 1214, a LIMIT primitive 1215, and a SINK node 1299.
   FIG. 12B depicts a second streaming query plan for a second streaming query. The second streaming query is a continuous query calculating, every 2 seconds, the top-50 HTTP hosts suffering from the highest peak round trip times, based on measurements collected during the last 5 minutes. This second streaming query may be may be generated from the following streaming query expression.
SELECT http_host, MAX(max_rtt) as max_roundtrip
FROM EventSource.win:time(5 min)
GROUP-BY http_host
OUTPUT EVERY 2 seconds
ORDER-BY max_roundtrip DESC
LIMIT 50
   As noted above, the second streaming query plan 1220 for the second streaming query is depicted in FIG. 12B. As depicted in FIG. 12B, the second streaming query plan 1220 includes a SOURCE node 1201 (as the SOURCE nodes of the first streaming query and the second streaming query are expected to be the same), a PROJECT primitive 1222, an AGGREGATE primitive 1223, an ORDER-BY primitive 1224, a LIMIT primitive 1225, and a SINK node 1299 (as the SINK nodes of the first streaming query and the second streaming query are expected to be the same).

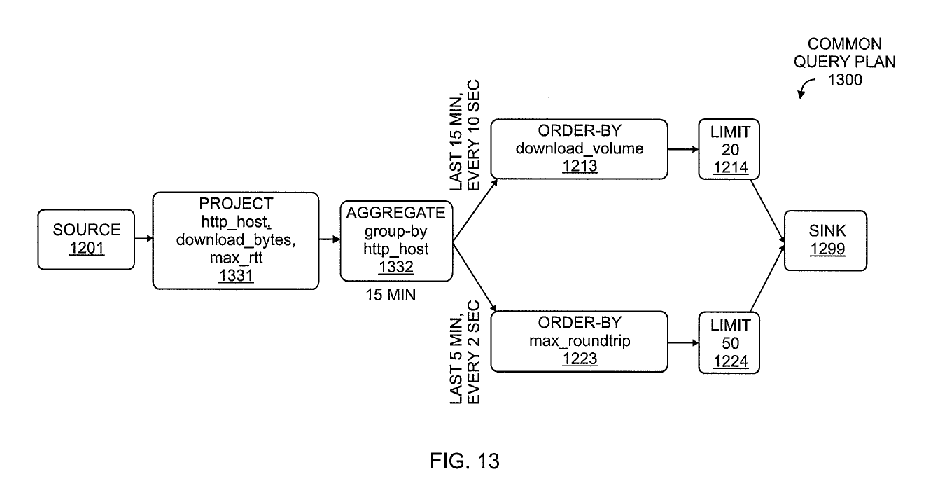

In at least some embodiments, SQCS 120 may be configured to improve or optimize deployment of multiple streaming queries to an environment where none of the multiple streaming queries have been activated within the environment. In general, when multiple streaming queries are being deployed to and activated within the environment at the same time, the aggregation windows of the multiple streaming queries may be shared if (1) the streaming queries demand the same type of aggregation window (e.g., size-based sliding window, size-based tumbling window, time-based sliding window, time-based tumbling window, or the like), (2) the common aggregation window supports the integration of multiple functions (thereby allowing each query to customize the output of the shared aggregation window), and (3) the streaming queries share the same aggregation input (e.g., event sources, data filters, join operations, or the like). The SQCS 120, based on a determination that these conditions are met for a set of multiple streaming queries where none of the streaming queries have been deployed and activated within the environment, may generate a single composed query plan for the multiple streaming queries, rather than generating multiple individualized query plans for the multiple streaming queries. In at least some embodiments, the generation of a single composed query plan for multiple streaming queries may differ from generation of multiple individualized query plans for the multiple streaming queries in the following ways: (1) a single PROJECT primitive, configured as a union of the projection attributes specified by the PROJECT primitives of the multiple queries, is included in the single composed query plan (rather than including separate PROJECT primitives including respective sets of projection attributes specified by the respective PROJECT primitives of the respective multiple queries), (2) a single AGGREGATE primitive providing a common aggregation window for the multiple streaming queries is included in the single composed query plan, the physical size of the common aggregation window of the single AGGREGATE primitive is set equal to the maximum aggregation window size from among the respective aggregation window sizes associated with the respective multiple queries, and virtual aggregation windows are allocated for the respective multiple streaming queries according to the respective aggregation window sizes of the respective multiple streaming queries, and (3) for each of the multiple streaming queries, any query primitives of the respective streaming query that follow the single AGGREGATE primitive are registered as being consumers of the single AGGREGATE primitive Accordingly, the SQCS 120 may generate a common query plan for multiple streaming queries by (1) combining common stages of the multiple streaming queries (e.g., the aggregation windows of the AGGREGATE primitives of the multiple streaming queries and, optionally, any other common stages of the multiple streaming queries that may be integrated), (2) modifying attributes of common stages of the multiple streaming queries that have been combined (e.g., setting the size of the common aggregation window of the combined AGGREGATE primitive to the maximum aggregate window size from among the multiple streaming queries, setting the set of projection attributes for a common PROJECT primitive to be a union of the respective sets of projection attributes of the respective PROJECT primitives of the respective multiple streaming queries, or the like), and (3) adding respective stages of the respective multiple streaming queries that follow the aggregation windows of the respective multiple streaming queries (e.g., respective ORDER-BY primitives, respective LIMIT primitives, or the like, as well as various combinations thereof). The SQCS 120 may then deploy and activate the multiple streaming queries within the environment by deploying and activating the single composed query plan for the multiple streaming queries. It will be appreciated that the single composed query plan may be deployed using a centralized deployment, using a distributed deployment (e.g., such as depicted and described with respect to FIGS. 2-7, or the like). The operation of SQCS 120 in improving or optimizing deployment of multiple streaming queries to an environment in this manner may be better understood by considering an example in which the streaming queries of FIGS. 12A and 12B have not yet been deployed or activated within the environment, as depicted and described with respect to FIG. 13.

FIG. 13 depicts an exemplary common query plan for the exemplary streaming queries of FIGS. 12A and 12B when exemplary streaming queries of FIGS. 12A and 12B have not been deployed or activated within the environment. The common query plan 1300 includes a SOURCE node 1201 and a SINK node 1299, which are the same as the SOURCE nodes 1201 and SINK nodes 1299 of the first streaming query plan 1210 and the second streaming query plan 1220 of FIGS. 12A and 12B. The SOURCE node 1201 connects to a PROJECT primitive 1331, which is configured in accordance with both the PROJECT primitive 1211 of the first streaming query plan 1210 and the PROJECT primitive 1221 of the second streaming query plan 1220. Namely, PROJECT primitive 1331 includes a set of projection attributes (http_host, download_bytes, max_rtt) which is a union of the set of projection attributes of the PROJECT primitive 1211 of the first streaming query plan 1210 (http_host, download_bytes) and the PROJECT primitive 1221 of the second streaming query plan 1220 (http_host, max_rtt). The PROJECT primitive 1331 connects to an AGGREGATE primitive 1332, which is configured in accordance with both the AGGREGATE primitive 1212 of the first streaming query plan 1210 and the AGGREGATE primitive 1222 of the second streaming query plan 1220. Namely, AGGREGATE primitive 1332 is configured to have an aggregation window size (15 minutes) that is the maximum size of the aggregation windows of the AGGREGATE primitive 1212 of the first streaming query plan 1210 (15 minutes) and the AGGREGATE primitive 1222 of the second streaming query plan 1220 (5 minutes). Here, the size of the aggregation window of the AGGREGATE primitive 1222 of the second streaming query plan 1220 is a multiple of the size of the aggregation window of the AGGREGATE primitive 1212 of the first streaming query plan 1210, thereby supporting aggregation by and output from the AGGREGATE primitive 1332 in a manner supporting both the first streaming query plan 1210 and the second streaming query plan 1220. The output of the AGGREGATE primitive 1332 branches into two parallel paths that include remaining portions of the first streaming query plan 1210 and the second streaming query plan 1220, respectively. For the first streaming query plan 1210, AGGREGATE primitive 1332 outputs results for the last 15 minutes, every 10 seconds, to the ORDER-BY primitive 1213 (which, as indicated in the first streaming query plan 1210 of FIG. 12A, orders results based on the download_volume attribute), ORDER-BY primitive 1213 outputs results to the LIMIT primitive 1214 (which, as indicated in the first streaming query plan 1210 of FIG. 12A, limits the results to the top 20 HTTP hosts based on download_volume), and the LIMIT primitive 1214 outputs results to SINK node 1299. Similarly, for the second streaming query plan 1220, AGGREGATE primitive 1332 outputs results for the last 5 minutes, every 2 seconds, to the ORDER-BY primitive 1223 (which, as indicated in the second streaming query plan 1220 of FIG. 12B, orders results based on the max_rtt attribute), ORDER-BY primitive 1223 outputs results to the LIMIT primitive 1224 (which, as indicated in the second streaming query plan 1220 of FIG. 12B, limits the results to the top 50 HTTP hosts based on roundtrip time), and the LIMIT primitive 1224 outputs results to SINK node 1299.

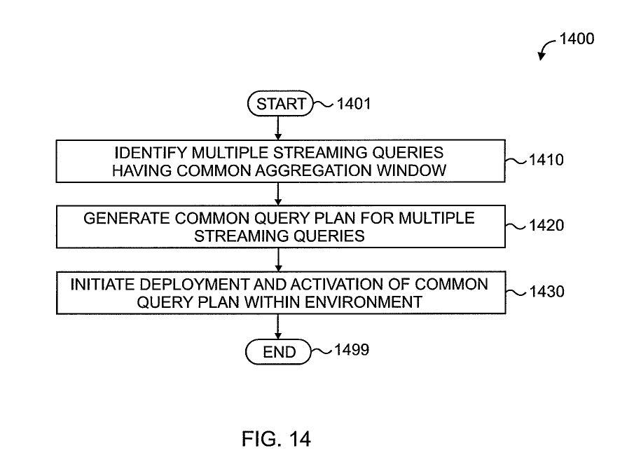

FIG. 14 depicts an exemplary embodiment of a method for creating a common streaming query plan for multiple streaming queries that have not been deployed or activated within the environment. It will be appreciated that, although primarily depicted and described as being performed serially, at least a portion of the steps of method 1400 may be performed contemporaneously, or in a different order than depicted in FIG. 14.

At step 1401, method 1400 begins.

At step 1410, multiple streaming queries having a common aggregation window are identified.

At step 1420, a common query plan is generated for the multiple streaming queries. The common query plan includes an aggregation component configured to have the common aggregation window of the multiple streaming queries.

At step 1430, deployment and activation of the common query plan within the environment is initiated. This also may be considered to be deployment and activation of the multiple streaming queries within the environment based on the common query plan. The deployment and activation of the common query plan within the environment results in an integrated deployment and execution of the multiple streaming queries within the environment.

At step 1499, method 1400 ends.

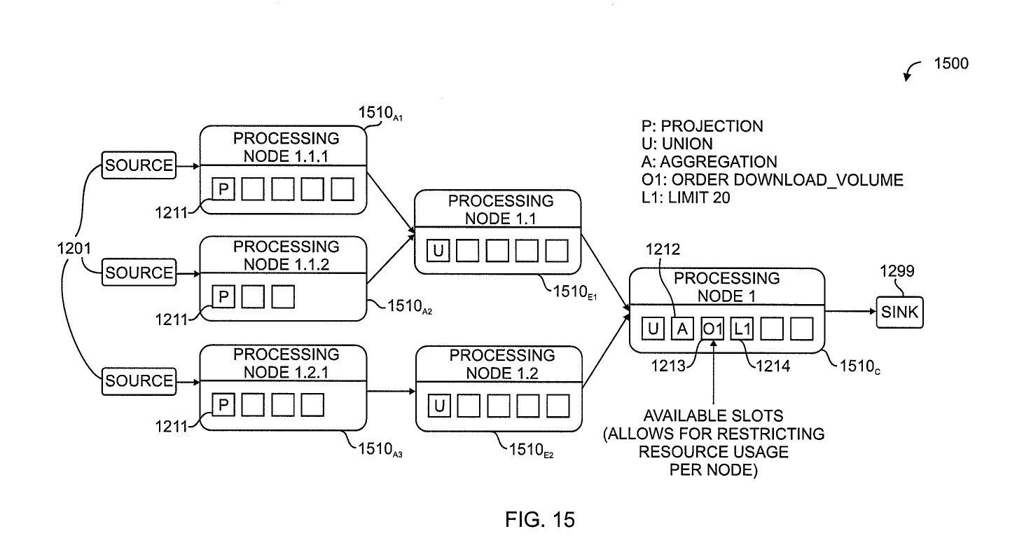

In at least some embodiments, SQCS 120 may be configured to improve or optimize deployment of multiple streaming queries to an environment where one or more of the streaming queries have been activated within the environment and one or more of the streaming queries have not yet been activated within the environment. This may be better understood by considering the case in which the multiple streaming queries include one streaming query that has been activated within the environment and one streaming query that has not yet been activated within the environment. The SQCS 120 may generate a sub-query plan that (1) includes, as the SOURCE node, an AGGREGATE primitive configured with the common aggregation window of the multiple streaming queries and (2) for the streaming query that has not yet been activated within the environment, includes any post-aggregation stages of the streaming query (e.g., any query primitives following the AGGREGATE primitive) as stages that connect the SOURCE node to the SINK node. The SQCS 120 may then deploy and activate the sub-query plan within the environment. The SQCS 120 may deploy and activate the sub-query plan within the environment by (1) registering the sub-query as a consumer of the AGGREGATE primitive that is to provide the common aggregation window for the multiple streaming queries, (2) ensuring that the aggregation window size of the AGGREGATE primitive that is already deployed within the environment (and, thus, that is to provide the common aggregation window for the multiple streaming queries) is set to a maximum aggregation window size from among the aggregation window sizes of the respective multiple streaming queries (which may include dynamically updating the aggregation window size of the AGGREGATE primitive to the maximum aggregation window size of the streaming query associated with the sub-query plan, and (3) ensuring that the projection attributes specified by the PROJECT primitive that is already deployed within the environment includes a union of the projection attributes specified by the PROJECT primitives of the multiple streaming queries (which may include dynamically updating the set of projection attributes of the PROJECT primitive that is already deployed within the environment). The operation of SQCS 120 in improving or optimizing deployment of multiple streaming queries to an environment in this manner may be better understood by considering an example in which the first streaming query of FIG. 12A has been deployed and activated within the environment and the second streaming query of FIG. 12B has not yet been deployed or activated within the environment, as depicted and described with respect to FIGS. 15-17.

FIG. 15 depicts an exemplary deployment of the streaming query of FIG. 12A within an exemplary communication network.

As depicted in FIG. 15, the communication network 1500 of FIG. 15 is similar to the exemplary communication network 500 of FIG. 5, with the exception that DCs 510 of FIG. 5 are replaced by processing nodes 1501. Namely, the communication network 1500 includes three first-layer processing nodes 1510_{A1}-1510_{A3} (collectively, first-layer processing nodes 1510_{A}, which also are marked as Processing Nodes 1.1.1, 1.1.2, and 1.2.1, respectively), two second-layer processing nodes 1510_{E1}-1510_{E2} (collectively, second-layer processing nodes 1510_{E}, which also are marked as Processing Nodes 1.1 and 1.2, respectively), and a single third-layer processing node 1510_{C} (which also is marked as Processing Node 1).

As further depicted in FIG. 15, the deployment of the first streaming query of FIG. 12A within the communication network 1500 of FIG. 15 includes (1) deployment of the PROJECT primitive (denoted as P) on each first-layer processing node 1510_{A1}-1510_{A3}, respectively, (2) deployment of two UNION primitives (denoted as U) on the two second-layer processing nodes 1510_{E1}-1510_{E2}, respectively, and (3) deployment of UNION (denoted as U), AGGREGATE (denoted as A), ORDER (denoted as O1, and based on download_vol), and LIMIT (denoted as L1, and having a limit of 20) primitives on the third-layer processing node 1510_{C}.

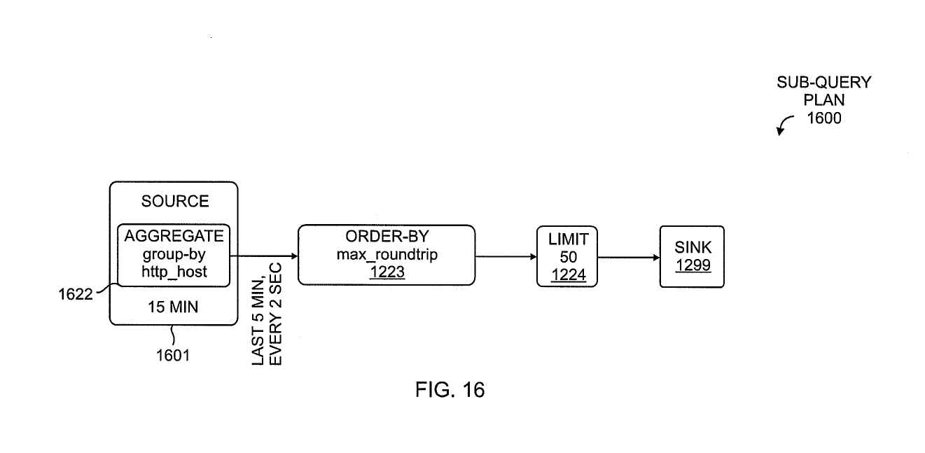

FIG. 16 depicts an exemplary sub-query plan for the streaming query of FIG. 12B, to provide an integrated deployment of the exemplary streaming queries of FIGS. 12A and 12B within the environment, when the query plan of FIG. 12A has been deployed to the environment as depicted in FIG. 15 and the query plan of FIG. 12B has not been deployed or activated within the environment. The sub-query plan 1600 includes a SOURCE node 1601 which includes a modified version of the AGGREGATE primitive 1222 of second streaming query plan 1220 of FIG. 12B (denoted as AGGREGATE primitive 1622). The AGGREGATE primitive 1622 is the same as AGGREGATE primitive 1222 of second streaming query plan 1220 in terms of the attributes to be aggregated, but is modified to include the maximum aggregation window size (namely, 15 minutes from the first streaming query plan 1210 of FIG. 12A) from among the aggregation window sizes of the respective multiple streaming queries. The sub-query plan 1600, downstream of the SOURCE node 1601 including the AGGREGATE primitive 1622, includes the remainder of the second streaming query plan 1220 of the second streaming query from FIG. 12B (illustratively, ORDER-BY primitive 1223, LIMIT primitive 1224, and SINK node 1299).

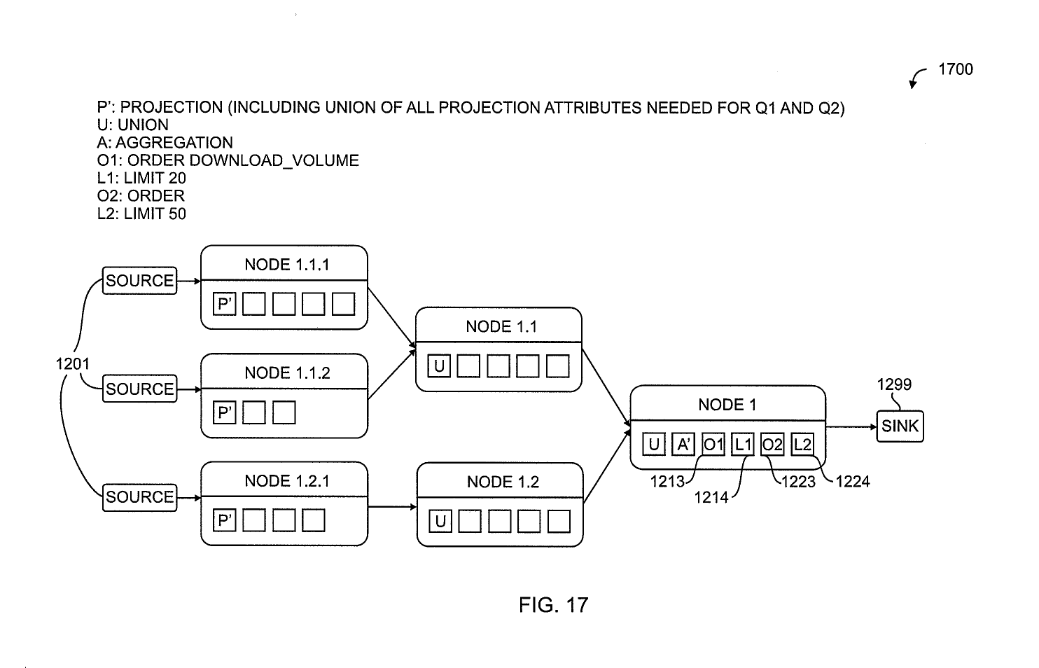

FIG. 17 depicts an exemplary deployment of the sub-query plan of FIG. 16 to provide an integrated deployment of the exemplary streaming queries of FIGS. 12A and 12B within the communication network of FIG. 15. As depicted in FIG. 17, the three instances of the PROJECT primitive, previously deployed on the three first-layer processing nodes 1510_{A1}-1510_{A3} when the first streaming query of FIG. 12A was deployed within communication network 1500, are dynamically updated to include a set of projection attributes that represent a union of the projection attributes of the first streaming query of FIG. 12A and the projection attributes of the second streaming query of FIG. 12B (namely, since the projection attributes of the first streaming query of FIG. 12A were previously deployed when the first streaming query of FIG. 12A was deployed within communication network 1500, the projection attributes of the second streaming query of FIG. 12B are now also added to the deployment). As further depicted in FIG. 17, a modified AGGREGATE primitive 1622 (denoted as A′, and modified as discussed with respect to sub-query plan 1600 of FIG. 16), ORDER-BY primitive 1223 (denoted as O2), and LIMIT primitive 1224 (denoted as L2) are deployed and activated within the third-layer processing node 1510_{C}.

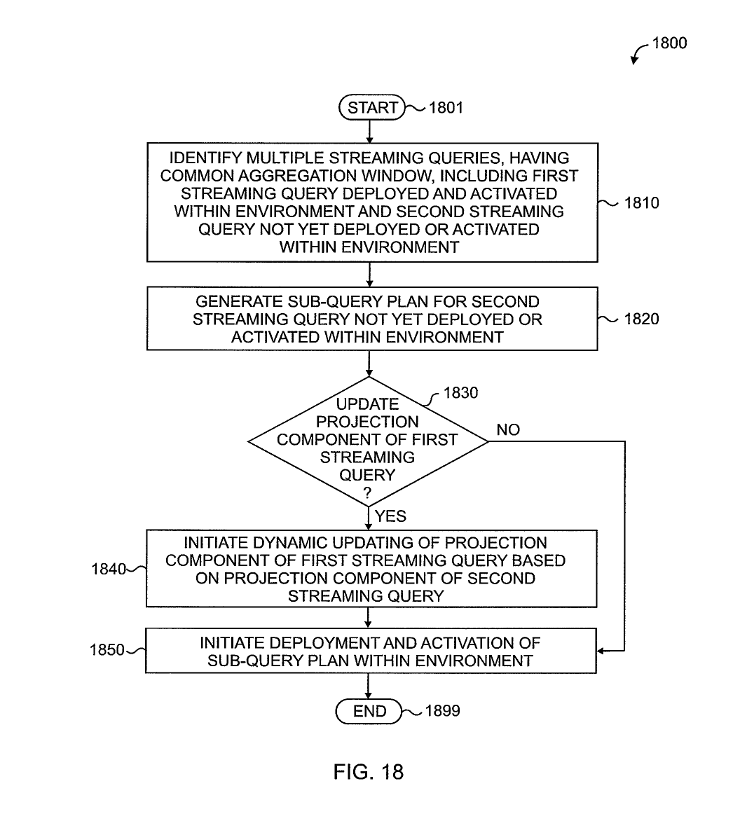

FIG. 18 depicts an exemplary embodiment of a method for providing an integrated deployment of multiple streaming queries that include a streaming query that has been deployed and activated within the environment and a streaming query that has not been deployed or activated within the environment. It will be appreciated that, although primarily depicted and described as being performed serially, at least a portion of the steps of method 1800 may be performed contemporaneously, or in a different order than depicted in FIG. 18.

At step 1801, method 1800 begins.

At step 1810, multiple streaming queries having a common aggregation window are identified. The multiple streaming queries include a first streaming query that has been deployed and activated within the environment and a second streaming query that has not yet been deployed or activated within the environment.

At step 1820, a sub-query plan is generated for the second streaming query. The sub-query plan includes an aggregation component, configured to have the common aggregation window of the multiple streaming queries, as its source node. The sub-query plan includes any other query components of the second streaming query following the aggregation component.

At step 1830, a determination is made as to whether the projection component of the first streaming query that has been deployed and activated within the environment is to be updated to include one or more projection attributes of the second streaming query that has not yet been deployed or activated within the environment. If the projection component of the first streaming query is not to be updated (e.g., the set of projection attributes of the second streaming query is equal to or a subset of the set of projection attributes of the first streaming query), method 1800 proceeds to step 1850. If the projection component of the first streaming query is to be updated (e.g., the set of projection attributes of the second streaming query includes one or more projection attributes not included in the set of projection attributes of the first streaming query), method 1800 proceeds to step 1840.

At step 1840, dynamic modification of the projection component that has been deployed and activated within the environment is initiated.

At step 1850, deployment and activation of the sub-query plan within the environment is initiated. This also may be considered to be deployment and activation of the second streaming query within the environment based on the sub-query plan. The deployment and activation of the sub-query plan within the environment results in an integrated deployment and execution of the multiple streaming queries within the environment.

At step 1899, method 1800 ends.

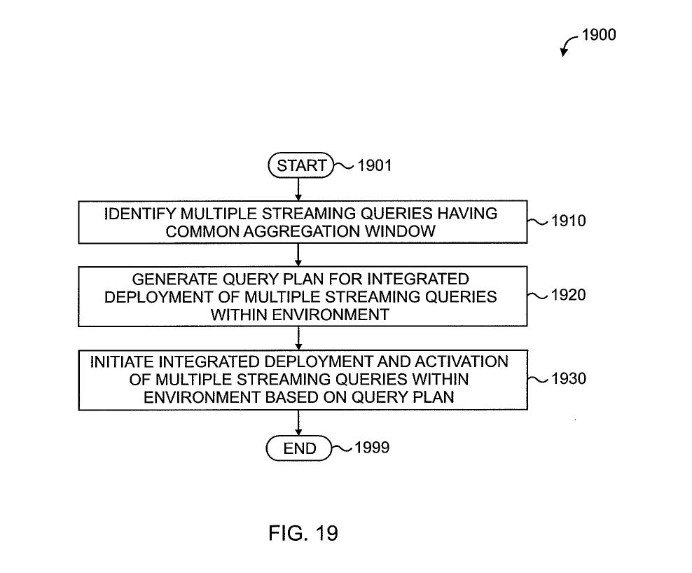

FIG. 19 depicts an exemplary embodiment of a method for providing an integrated deployment of multiple streaming queries. It will be appreciated that, although primarily depicted and described as being performed serially, at least a portion of the steps of method 1900 may be performed contemporaneously, or in a different order than depicted in FIG. 19. At step 1901, method 1900 begins. At step 1910, multiple streaming queries having a common aggregation window are identified. At step 1920, a query plan for integrated deployment of the multiple streaming queries to the environment is generated. In at least some embodiments, in which none of the multiple streaming queries have been deployed to the environment, the generation of the query plan may include generation of a common query plan as depicted and described with respect to FIGS. 13 and 14. In at least some embodiments, in which one or more of the multiple streaming queries have already been deployed to the environment and one or more of the multiple streaming queries have not yet been deployed to the environment, generation of the query plan may include generation of a sub-query query plan as depicted and described with respect to FIGS. 15-18. At step 1930, integrated deployment and activation of the multiple streaming queries within the environment is initiated based on the query plan. It will be appreciated that this is described as being initiation of an integrated deployment, because, in at least some cases, one or more of the streaming queries may already have been deployed and activated within the environment. At step 1999, method 1900 ends.

As discussed above, although primarily depicted and described herein with respect to embodiments in which the common characteristic of the multiple streaming queries is a common aggregation window of the multiple streaming queries, it will be appreciated that other types of characteristics may be exploited to provide various other types of improvements and optimizations. For example, the common characteristic of the multiple streaming queries may be associated with usage of resources (e.g., processing resources, memory resources, storage resources, bandwidth resources, or the like, as well as various combinations thereof) used for deployment or execution of the multiple streaming queries within the environment. Accordingly, in at least some embodiments, a capability may include steps or functions of identifying a first streaming query and a second streaming query sharing a common characteristic (e.g., a common characteristic associated with or impacting resource consumption, of one or more resource types, for deployment or execution of the first streaming query and the second streaming query) and determining, based on the common characteristic, a query plan configured to provide integrated deployment of the first streaming query and the second streaming query within an environment.

It will be appreciated that, although primarily depicted and described herein within the context of use of a specific type of query (namely, top-N queries), various embodiments of the streaming query control capability may be utilized for improving or optimizing streaming queries for other types of queries which may be implemented as streaming queries.

It will be appreciated that, although primarily depicted and described herein with respect to use of streaming queries within a specific type of environment (namely, a communication network), various embodiments of the streaming query control capability may be utilized for improving or optimizing streaming queries within various other types of environments in which streaming queries may be used (e.g., within a processor or other type of hardware, within a computer, within a network node, within sensor networks or environments, within financial environments supporting propagation of ticker information, within environments of manufacturing processes, or the like).

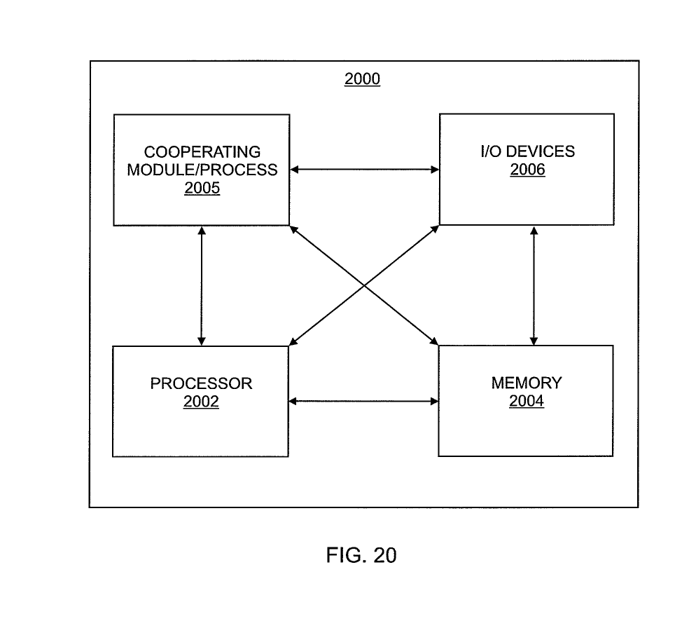

FIG. 20 depicts a high-level block diagram of a computer suitable for use in performing functions described herein.

The computer 2000 includes a processor 2002 (e.g., a central processing unit (CPU) and/or other suitable processor(s)) and a memory 404 (e.g., random access memory (RAM), read only memory (ROM), and the like).

The computer 2000 also may include a cooperating module/process 2005. The cooperating process 2005 can be loaded into memory 2004 and executed by the processor 2002 to implement functions as discussed herein and, thus, cooperating process 2005 (including associated data structures) can be stored on a computer readable storage medium, e.g., RAM memory, magnetic or optical drive or diskette, and the like.

The computer 2000 also may include one or more input/output devices 2006 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 2000 depicted in FIG. 20 provides a general architecture and functionality suitable for implementing functional elements described herein and/or portions of functional elements described herein. For example, computer 2100 provides a general architecture and functionality suitable for implementing one or more of a processing node 112, a portion of a processing node 112, SQCS 120, a portion of SQCS 120, SQCS 300, a portion of SQCS 300, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
determine a centralized query plan configured to provide a centralized deployment of the streaming query;
determine a tree representing a distributed environment in which the streaming query is to be deployed; and
determine, based on the centralized query plan and the tree representing the distributed environment in which the streaming query is to be deployed, a distributed query plan configured to provide a distributed deployment of the streaming query within the distributed environment.

2. The apparatus of claim 1, wherein, to determine the centralized query plan, the processor is configured to:
process a query expression for the streaming query to form an abstract syntax tree (AST) for the streaming query; and
process the AST to determine therefrom the centralized query plan.

3. The apparatus of claim 1, wherein, to determine a tree representing a distributed environment in which the streaming query is to be deployed, the processor is configured to:
receive a description of the distributed environment that includes a set of vertices representing a set of processing nodes of the distributed environment a set of edges representing communication paths between respective pairs of processing nodes of the distributed environment; and
process the description of the distributed environment to determine the tree representing the distributed environment.

4. The apparatus of claim 3, wherein the streaming query has one or more event sources and an event sink associated therewith, wherein the tree representing the distributed environment comprises a shortest path tree including a set of shortest communication paths from the one or more event sources to the event sink.

5. The apparatus of claim 4, wherein the edges have associated therewith respective weights indicative of respective costs associated with the communication paths, wherein the tree representing the distributed environment comprises a shortest path and lowest cost tree.

6. The apparatus of claim 5, wherein the shortest path and lowest cost tree representing the distributed environment comprises a minimal Steiner tree.

7. The apparatus of claim 1, wherein the centralized query plan comprises a set of query primitives, wherein the tree representing the distributed environment comprises a set of vertices representing a set of processing nodes of the distributed environment, wherein, to determine the distributed query plan, the processor is configured to:
determine, for each of the query primitives of the centralized query plan, a mapping of the query primitive onto one or more of the vertices of the tree representing the distributed environment.

8. The apparatus of claim 1, wherein the processor is configured to:
determine, based on the distributed query plan, a distributed query deployment plan for deployment and activation of the streaming query within the environment.

9. The apparatus of claim 8, wherein, to determine the distributed query deployment plan, the processor is configured to:
determine, for each of the query primitives of the distributed query plan, a mapping of the query primitive onto one or more processing nodes of the distributed environment represented by one or more vertices of the tree representing the distributed environment.

10. A method, comprising:
using a processor and a memory for:
determining a centralized query plan configured to provide a centralized deployment of the streaming query;
determining a tree representing a distributed environment in which the streaming query is to be deployed; and
determining, based on the centralized query plan and the tree representing the distributed environment in which the streaming query is to be deployed, a distributed query plan configured to provide a distributed deployment of the streaming query within the distributed environment.

11. An apparatus, comprising:
a processor and a memory communicatively connected to the processor, the processor configured to:
identify a first streaming query and a second streaming query sharing a common characteristic; and
determine, based on the common characteristic, a query plan configured for integrated deployment and execution of the first streaming query and the second streaming query within an environment.

12. The apparatus of claim 11, wherein the first streaming query and the second streaming query are not deployed within the environment prior to determination of the query plan.

13. The apparatus of claim 12, wherein, to determine the query plan, the processor is configured to:
combine a first query primitive of the first streaming query and a second query primitive of the second streaming query to form a common query primitive, the first and second query primitives being of a common query primitive type; and
add stages of the first streaming query that follow the first query primitive as a first sequence of query primitives to a sink node; and
add stages of the second streaming query that follow the second query primitive as a second sequence of query primitives to the sink node.

14. The apparatus of claim 13, wherein the processor is configured to:
determine a set of attributes of the common query primitive based on a first set of attributes of the first query primitive and a second set of attributes of the second query primitive.

15. The apparatus of claim 13, wherein the common query primitive comprises a PROJECT primitive, wherein, to determine the set of attributes of the common query primitive, the processor is configured to:
compute a union of the first set of attributes of the first query primitive and the second set of attributes of the second query primitive.

16. The apparatus of claim 11, wherein the first streaming query is deployed within the environment prior to determination of the query plan and the second streaming query is not deployed within the environment prior to determination of the query plan.

17. The apparatus of claim 16, wherein, to determine the query plan, the processor is configured to:
determine, for the second streaming query, a sub-query plan comprising:
a source node including a common query primitive having an attribute shared by a first query primitive of the first streaming query and a second query primitive of the second streaming query; and
a sequence of query primitives from the source node to a sink node, the sequence of query primitives comprising any additional query primitives of the second streaming query that follow the second query primitive of the second streaming query.

18. The apparatus of claim 17, wherein the common query primitive is a common AGGREGATE primitive, wherein the attribute comprises a maximum aggregation window size determined based on a first aggregation window size associated with the first streaming query and a second aggregation window size associated with the second streaming query.

19. The apparatus of claim 17, wherein the processor is configured to:
register the sequence of query primitives of the sub-query plan as a consumer of a first query primitive of the first streaming query that is already deployed within the environment.

20. A method, comprising:
using a processor and a memory for:
identifying a first streaming query and a second streaming query sharing a common characteristic; and
determining, based on the common characteristic, a query plan configured for integrated deployment and execution of the first streaming query and the second streaming query within an environment.
